(19) United States
(12) Patent Application Publication
(10) Pub. No.: US 2013/0319512 A1
(43) Pub. Date: Dec. 5, 2013

(54) ELECTRODE, PHOTOELECTRIC CONVERSION ELEMENT, ELECTRONIC APPARATUS AND ARCHITECTURAL STRUCTURE

(71) Applicant: Sony Corporation, Tokyo (JP)

(72) Inventors: Yoshiaki Obana, Kanagawa (JP); Ryo Sasaki, Kanagawa (JP); Harumi Shibata, Kanagawa (JP); Yusuke Suzuki, Kanagawa (JP)

(73) Assignee: Sony Corporation, Tokyo (JP)

(21) Appl. No.: 13/903,822

(22) Filed: May 28, 2013

(30) Foreign Application Priority Data
Jun. 4, 2012 (JP) 2012126733

(51) Int. Cl. H01G 9/20

(52) U.S. Cl. CPC H01G 9/2022
USPC 136/254; 252/510; 252/506; 252/507; 252/508; 252/511

(57) ABSTRACT

An electrode includes carbon black, a fibrous carbon material and an organic binder. The carbon black (A) and the fibrous carbon material (B) are in a mass ratio (B/A) within the range of from 10/90 to 50/50.

### BACKGROUND

The present disclosure relates to an electrode, a photoelectric conversion element, an electronic apparatus and an architectural structure. More particularly, the present disclosure relates to an electrode containing a carbon material, a photoelectric conversion element using this electrode, and an electronic apparatus and an architectural structure using this photoelectric conversion element.

Since solar cells, which are photoelectric conversion elements for converting sunlight into electrical energy, use sunlight as an energy source, solar cells have very little impact on the global environment and are expected to be more and more popularized. Examples of solar cells which have mainly been used from the past are crystalline silicon solar cells using monocrystalline or polycrystalline silicon; and amorphous silicon solar cells. Meanwhile, dye-sensitized solar cells proposed by Gratzel et al. in 1991 have been drawing attention for their capability to obtain high photoelectric conversion efficiency, and moreover, for being able to be manufactured at a low cost as they do not require a large-scale apparatus in the manufacture unlike the silicon solar cells in the past (for example, see Nature, 353, p. 737-740, 1991).

A dye-sensitized solar cell in general has a structure filled with an electrolyte layer made of electrolyte solution between a porous electrode made of materials such as titanium oxide (TiO₂) to which a photosensitizing dye is bound, and a counter electrode which is a photocatalyst layer. As the electrolyte solution, one in which an electrolyte containing iodine (I) or redox species such as iodide ion (I⁻) is dissolved in a solvent is often used.

In the past, as the counter electrode of the dye-sensitized solar cell, a platinum layer has been mainly used because it has both the superior catalytic activity and corrosion resistance, for example. Examples of methods used in forming the platinum layer include sputtering; wet method to release platinum by thermal decomposition of chloroplatinic acid after coating of the solution of chloroplatinic acid; and other methods. Platinum layers in general have excellent catalytic activity, corrosion resistance, electrical conductivity and the like. However, depending on the electrolyte to be used, dissolution of platinum may occur and this may lead to deterioration of power generation characteristics. Further, platinum is a rare resource and is expensive; and since a high vacuum process or a high-temperature process would be necessary in the formation of platinum layers, their manufacturing facilities need to be large.

Accordingly, in recent years, the use of chemically stable carbon instead of platinum as a counter electrode material has been under study (for example, see Japanese Patent Application Laid-open Nos. 2003-142168, 2004-111216, 2004-127849 and 2004-152747). The carbon selected to be used as a counter electrode material include a carbon black which has a particularly high catalytic activity. After mixing the carbon black with a solvent, and the like, to be prepared into a carbon paste, by this carbon paste being coated onto a substrate and dried, the counter electrode as a catalyst layer would be formed. The carbon counter electrode formed by using this method has been reported to be capable of realizing the performances similar to platinum counter electrodes (for example, see J Electrochem Soc., 153(12), (2006)A2255).

Specifically, Japanese Patent Application Laid-open No. 2004-152747 discloses a carbon electrode made up of carbon black-like particles, columnar conductive carbon material particles and anatase-type titanium dioxide particles, which materials are in a specific mass ratio. Further, in Japanese Patent Application Laid-open No. 2004-152747, as a method for manufacturing the carbon electrode, a technique in which a paste is prepared by mixing the carbon black-like particles, columnar conductive carbon material particles and anatase-type titanium dioxide particles, and after the paste was coated onto a substrate, the carbon electrode would be prepared at an elevated temperature of 450° C.

### SUMMARY

However, with such carbon electrodes that have been proposed in the past, it is difficult to realize a dye-sensitized solar cell which is excellent in conversion efficiency and durability.

In view of the above-mentioned circumstances, it is desirable to provide an electrode which is excellent in conversion efficiency and durability, and to provide a photoelectric conversion element including this electrode.

It is also desirable to provide an electronic apparatus using such an excellent photoelectric conversion element as mentioned above.

Further, it is desirable to provide an architectural structure using such an excellent photoelectric conversion element as mentioned above as well.

According to an embodiment of the present disclosure, there is provided an electrode including carbon black, a fibrous carbon material and an organic binder. The carbon black (A) and the fibrous carbon material (B) are in a mass ratio (B/A) within the range of from 10/90 to 50/50.

According to another embodiment of the present disclosure, there is provided a photoelectric conversion element including a photoelectrode, an electrolyte layer and a counter electrode, which counter electrode includes carbon black, a fibrous carbon material and an organic binder. The carbon black (A) and the fibrous carbon material (B) are in a mass ratio (B/A) within the range of from 10/90 to 50/50.

According to still another embodiment of the present disclosure, there is provided an electronic apparatus including at least one photoelectric conversion element. The photoelectric conversion element includes a photoelectrode, an electrolyte layer and a counter electrode. The counter electrode includes carbon black, a fibrous carbon material and an organic binder. The carbon black (A) and the fibrous carbon material (B) are in a mass ratio (B/A) within the range of from 10/90 to 50/50.

According to still another embodiment of the present disclosure, there is provided an architectural structure including at least one photoelectric conversion element. The photoelectric conversion element includes a photoelectrode, an electrolyte layer and a counter electrode. The counter electrode includes carbon black, a fibrous carbon material and an organic binder. The carbon black (A) and the fibrous carbon material (B) are in a mass ratio (B/A) within the range of from 10/90 to 50/50.

Basically, examples of the electronic apparatus may include any electronic apparatus, including both portable type and stationary type. Specific examples thereof include mobile phones, mobile devices, robots, personal computers, automotive equipment, various household appliances and the like. In such cases, the photoelectric conversion element serves as a solar cell which is used as a power source of these electronic apparatus.

The architectural structure typically is a large architecture such as a building or an apartment, but is not limited thereto. Basically, the architectural structures may be any structures built, having outer wall surfaces. Specific examples of the architectural structures include houses, apartments, stations, buildings, government buildings, stadiums, ballparks, hospitals, churches, factories, warehouses, huts, garages, bridges and the like. The architectural structures particularly may be desirable to include a constructed structure having at least one window (for example, glass window) or part for daylighting, but are not limited to these or the above-mentioned examples.

Among the at least one photoelectric conversion element and/or a module of photoelectric conversion elements in which a plurality of photoelectric conversion elements is electrically connected provided in the architectural structure, one which is provided in a part such as the window or the part for daylighting is desirable to be configured by being sandwiched between two transparent plates and by being fixed as necessary. This typically may be configured by embedding the at least one photoelectric conversion element and/or the photoelectric conversion element module between two glass plates and fixing them as necessary.

Basically, transparent materials which make up the transparent plates may be any materials that are transparent and are easy to transmit light. Specific examples of the transparent materials include transparent inorganic materials, transparent resins and the like. Examples of transparent inorganic materials include silica glass, borosilicate glass, phosphate glass, soda glass and the like. Examples of transparent resins include polyethylene terephthalate, polyethylene naphthalate, polybutylene terephthalate, acetyl cellulose, tetraacetyl cellulose, polyphenylene sulfide, polycarbonate, polyethylene, polypropylene, polyvinylidene fluoride, brominated phenoxy, aramids, polyimides, polystyrenes, polyarylates, polysulfones, polyolefins and the like. However, the transparent materials are not limited thereto.

In addition, those sandwiching at least one photoelectric conversion element and/or the photoelectric conversion element module are not limited to the transparent plates, but may be transparent material formed in such as sphere, ellipsoidal, polyhedral, cone, frustum, columnar or lens bodies.

As described above, according to the embodiments of the present disclosure, an electrode which is excellent in conversion efficiency and durability, and a photoelectric conversion element including this electrode can be provided.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1A is a cross-sectional view showing a configuration example of a photoelectric conversion element according to an embodiment of the present disclosure;

FIG. 1B is a cross-sectional view showing a part of a counter electrode shown in FIG. 1A in an enlarged manner;

FIG. 2 is a graph showing evaluation results of conversion efficiency (initial characteristics) of dye-sensitized solar cells of Examples 1-1, 2-1 to 2-6 and Comparative Examples 2-1 and 2-2;

FIGS. 3A and 3B are graphs showing evaluation results of durability of dye-sensitized solar cells of Examples 1-1, 2-2, 2-3 and 2-5;

FIGS. 4A and 4B are graphs showing evaluation results of durability of dye-sensitized solar cells of Examples 1-1, 2-2, 2-3 and 2-5;

FIG. 5 is a graph showing evaluation results of conversion efficiency (initial characteristics) of dye-sensitized solar cells of Examples 1-1 and 3-1 to 3-6;

FIG. 6 is a graph showing evaluation results of conversion efficiency (initial characteristics) of dye-sensitized solar cells of Examples 4-1 to 4-5;

FIGS. 7A and 7B are graphs showing evaluation results of durability of dye-sensitized solar cells of Examples 4-3 to 4-5;

FIGS. 8A and 8B are graphs showing evaluation results of durability of dye-sensitized solar cells of Examples 4-3 to 4-5;

FIGS. 9A and 9B are graphs showing evaluation results of durability of dye-sensitized solar cells of Examples 6-3 and 7-1 to 7-3;

FIGS. 10A and 10B are graphs showing evaluation results of durability of dye-sensitized solar cells of Examples 6-3 and 7-1 to 7-3;

FIGS. 11A and 11B are graphs showing evaluation results of durability of dye-sensitized solar cells of Examples 3-3 and 8-2 to 8-4;

FIGS. 12A and 12B are graphs showing evaluation results of durability of dye-sensitized solar cells of Examples 3-3 and 8-2 to 8-4;

FIGS. 13A and 13B are graphs showing evaluation results of durability of dye-sensitized solar cells of Examples 1-1, 9-2 and 9-6;

FIGS. 14A and 14B are graphs showing evaluation results of durability of dye-sensitized solar cells of Examples 1-1, 9-2 and 9-6;

FIGS. 15A and 15B are graphs showing evaluation results of durability of dye-sensitized solar cells of Examples 1-1, 10-1 to 10-3 and Comparative Example 10-1;

FIGS. 16A and 16B are graphs showing evaluation results of durability of dye-sensitized solar cells of Examples 1-1, 10-1 to 10-3 and Comparative Example 10-1;

FIGS. 17A and 17B are graphs showing evaluation results of durability of dye-sensitized solar cells of Examples 11-1 to 11-4;

FIGS. 18A and 18B are graphs showing evaluation results of durability of dye-sensitized solar cells of Examples 11-1 to 11-4;

FIGS. 19A and 19B are figures showing SEM images of a carbon counter electrode of Example 11-1;

FIGS. 20A and 20B are figures showing SEM images of a carbon counter electrode of Example 11-2;

FIGS. 21A and 21B are figures showing SEM images of a carbon counter electrode of Example 11-3; and

FIGS. 22A and 22B are figures showing SEM images of a carbon counter electrode of Example 11-4.

### DETAILED DESCRIPTION OF EMBODIMENTS

Hereinafter, embodiments of the present disclosure will be described in the following order.

1. Outline

2. Configuration of dye-sensitized solar cell

3. Method for manufacturing dye-sensitized solar cell

4. Operation of dye-sensitized solar cell

### [1. Outline]

As described above, in the method for preparing carbon electrodes of the past, the carbon electrodes have been prepared by coating a paste onto substrates and by subsequently performing a sintering process at a high temperature (for example, 450° C. in Japanese Patent Application Laid-open No. 2004-152747). This is because the binding of the carbon is performed by using an inorganic oxide such as titanium oxide. Such a sintering process at high temperature consumes high energy and may be undesirable in terms of production costs.

In view of such circumstances, the present inventors studied the use of an organic binder that can be prepared even at a low temperature, in combination with carbon black and a conductive carbon material. As a result, surprisingly, it was found that by adjusting the ratio of the carbon black and a fibrous carbon material within a predetermined range, superior conversion efficiency and durability can be realized; and the technology of the present disclosure was completed.

### [2. Configuration of Dye-Sensitized Solar Cell]

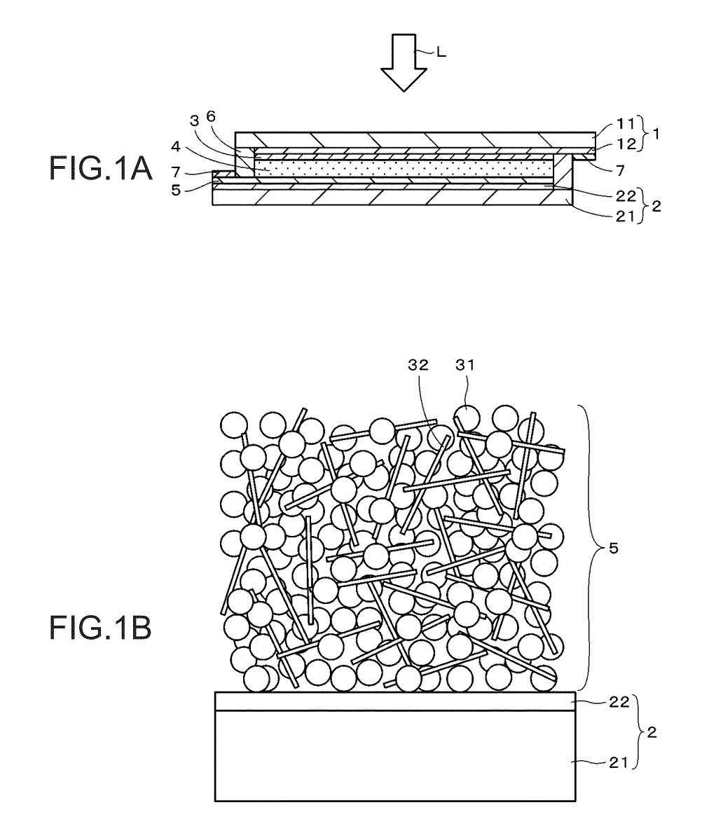

FIG. 1A is a cross-sectional view showing a configuration example of a dye-sensitized solar cell according to an embodiment of the present disclosure. As shown in FIG. 1A, this dye-sensitized solar cell (photoelectric conversion element) includes a transparent conductive base material 1, a transparent conductive base material 2, a porous semiconductor layer 3 supporting a dye, and an electrolyte layer 4, a counter electrode 5, and a sealing material 6. The transparent conductive base material 1 and the transparent conductive base material 2 are disposed opposite one another. The transparent conductive base material 1 has a main surface opposing the transparent conductive base material 2, and on this main surface, the porous semiconductor layer 3 is formed. The transparent conductive base material 2 has a main surface opposing the transparent conductive base material 1, and on this main surface, the counter electrode 5 is formed. Between the porous semiconductor layer 3 and the counter electrode 5 opposing each other, the electrolyte layer 4 is interposed. The transparent conductive base material 1 has another main surface on the side opposite from the main surface where the porous semiconductor layer 3 has been formed, and for example, this main surface of the opposite side serves as a light receiving surface to be irradiated with light L such as sunlight.

At the peripheral part of the opposing surfaces of the transparent conductive base material 1 and the transparent conductive base material 2, the sealing material 6 is provided. The distance between the porous semiconductor layer 3 and the counter electrode 5 desirably is from 1 to 100 μm, and more desirably, from 1 to 40 μm. The electrolyte layer 4 is sealed in a space surrounded by the transparent conductive base material 1 on which the porous semiconductor layer 3 is formed, the transparent conductive base material 2 on which the counter electrode 5 is formed and the sealing material 6. Examples of materials which can be employed as the sealing material 6 include, but are not limited to, a thermoplastic resin, photo-curable resin, glass frit, and the like.

Transparent conductive layers 12 and 22 have some part of a peripheral part thereof being exposed to the outside of the sealing material 6. On this exposed part of the transparent conductive layers 12 and 22, a current collector layer 7 is formed. This current collector layer 7 is used in connecting with external leads, or used in cases where the dye-sensitized solar cells are connected with each other.

Hereinafter, the transparent conductive base materials 1 and 2, the porous semiconductor layer 3, a sensitizing dye, the counter electrode 5 and the electrolyte layer 4, which make up this dye-sensitized solar cell, will be described in order.

### (Transparent Conductive Base Materials)

The transparent conductive base material 1 include a base material 11 and the transparent conductive layer 12 formed on a main surface of this base material 11, and the porous semiconductor layer 3 is formed on this transparent conductive layer 12. The transparent conductive base material 2 include a base material 21 and the transparent conductive layer 22 formed on a main surface of this base material 21, and the counter electrode 5 is formed on this transparent conductive layer 22. As the base materials 11 and 21, any of various base materials having transparency can be employed. The base materials having transparency are desirable to be those that show less light absorption with respect to the visible region to near-infrared region of sunlight. Examples of such base materials which can be employed include, but are not limited to, glass substrates, resin substrates, and the like. Examples of materials of glass substrates which can be employed include, but are not limited to, silica, blue plate, BK7, lead glass, and the like. Examples of materials of resin substrates which can be employed include, but are not limited to, polyethylene terephthalate (PET), polyethylene naphthalate (PEN), polyimide (PI), polyester, polyethylene (PE), polycarbonate (PC), polyvinyl butyrate, polypropylene (PP), tetraacetyl cellulose, syndiotactic polystyrene, polyphenylene sulfide, polyarylate, polysulfone, polyester sulfone, polyether imide, cyclic polyolefin, brominated phenoxy, vinyl chloride, and the like. Examples of the base materials 11 and 21 which can be employed include, but are not limited to, films, sheets, substrates, and the like.

The transparent conductive layers 12 and 22 are desirable to be those that show less light absorption with respect to the visible region to near-infrared region of sunlight. Examples of materials of the transparent conductive layers 12 and 22 which may desirably be employed include metal oxides with good electrical conductivity, and carbons. As such metal oxides, for example, at least one selected from the group consisting of indium-tin composite oxide (ITO), fluorine-doped SnO₂ (FTO), antimony-doped SnO₂ (ATO), tin oxide (SnO₂), zinc oxide (ZnO), indium-zinc composite oxide (IZO), zinc-aluminum composite oxide (AZO) and zinc-gallium composite oxide (GZO) can be employed. A layer for the purpose of facilitating binding, improving electron transfer, preventing reverse electron processes, or the like may be further provided between the transparent conductive layer 22 and the porous semiconductor layer 3.

### (Porous Semiconductor Layer)

The porous semiconductor layer 3 which is a porous semiconductor electrode (photoelectrode) is desirable to be a porous layer containing metal oxide semiconductor particulates. The metal oxide semiconductor particulates are desirable to be containing a metal oxide that includes at least one of titanium, zinc, tin and niobium. This is because by containing such a metal oxide, an appropriate energy band can be formed between the metal oxide and a dye to be adsorbed thereto; which can facilitate transfer of electrons generated by the subsequent irradiation of light in the dye, to the metal oxide; and can be contributed to the power generation by oxidation-reduction of iodine thereafter. Specific examples of materials of the metal oxide semiconductor particulates which can be employed include, but are not limited to, one or more selected from the group consisting of titanium oxide, tin oxide, tungsten oxide, zinc oxide, indium oxide, niobium oxide, iron oxide, nickel oxide, cobalt oxide, strontium oxide, tantalum oxide, antimony oxide, lanthanide oxides, yttrium oxide, vanadium oxide and the like. For sensitization of the surface of the porous metal oxide semiconductor layer by a sensitizing dye, the conduction band of the porous semiconductor layer 3 is desirably located on a position at which it can easily receive electrons from the photoexcited level of a sensitizing dye. From this point of view, in particular, among the above-mentioned materials of the metal oxide semiconductor particulates, one or more selected from the group consisting of titanium oxide, tin oxide, zinc oxide and niobium oxide is desirable. Further, from the viewpoint of cost, environmental hygiene and the like, titanium oxide may be especially desirable. The metal oxide semiconductor particulates are particularly desirable to be containing titanium oxide having crystal structure of brookite type or anatase type. This is because by containing such titanium oxide, an appropriate energy band can be formed between the metal oxide and a dye to be adsorbed thereto; which can facilitate transfer of electrons generated by the subsequent irradiation of light in the dye, to the metal oxide; and can be contributed to the power generation by oxidation-reduction of iodine thereafter. Further, an average primary particle diameter of the metal oxide semiconductor particulates is desirable to be 5 nm or more and 500 nm or less. If it is less than 5 nm, crystallinity of the metal oxide becomes extremely degraded, and the anatase structure may not be maintained, so it tends to be in amorphous structure. On the other hand, if it exceeds 500 nm, the specific surface area becomes significantly decreased, and the total amount of dye that contributes to power generation to adsorb on the porous semiconductor layer 3 tends to decrease. The average primary particle diameter herein is measured by light scattering method, using a solvent system in which primary particles can be dispersed, and using the dilute solution by adding a desired dispersant and subjecting to dispersion process to obtain the primary particles.

As the porous semiconductor layer 3, one including particulates of the so-called core-shell structure may be employed. Desirably, as this porous semiconductor layer 3, one made up with particulates which each include a metal core and a metal oxide shell surrounding the core may be employed. By using such a porous semiconductor layer 3, in cases where the electrolyte layer 4 is provided between this porous semiconductor layer 3 and the counter electrode 5, the electrolyte of the electrolyte layer 4 is prevented from making contact with the metal cores of the metal-metal oxide particulates, so dissolution of the porous semiconductor layer 3 by the electrolyte can be prevented. As a result, it is made possible to use, as a metal that makes up the cores of the metal-metal oxide particulates, metals such as gold (Au), silver (Ag) and copper (Cu) which show an effect of surface plasmon resonance and which have been difficult to be employed in the past. Consequently, in photoelectric conversion, the effect of the surface plasmon resonance can be sufficiently obtained. In addition, an iodine-based electrolyte can be used as the electrolyte of an electrolyte solution. Examples of metals which can be employed as the cores of the metal-metal oxide particulates also include platinum (Pt), palladium (Pd) and the like. As the metal oxide that makes up the shells of the metal-metal oxide particulates, a metal oxide which does not be dissolved in the electrolyte is employed, and is selected as necessary.

As such a metal oxide, desirably, at least one metal oxide selected from the group consisting of titanium oxide (TiO₂), tin oxide (SnO₂), niobium oxide (Nb₂O₅) and zinc oxide (ZnO) is employed. However, the metal oxide is not limited thereto. In addition, metal oxides such as tungsten oxide (WO₃) and strontium titanate (SrTiO₃) can also be used. The particle diameter of the particulates is selected as appropriate, and desirably, it may be 1 nm or more and 500 nm or less. Besides, the particle diameter of the cores of the particulates is also selected as appropriate, and desirably, it may be 1 nm or more and 200 nm or less.

### (Sensitizing Dye)

As an organic dye (spectral sensitizing dye) to be adsorbed to the porous semiconductor layer 3, one or more among various metal complexes and organic dyes, which have light absorption at the visible region and/or infrared region, can be used. Those which have at least one functional group of a carboxyl group, a hydroxyalkyl group, a hydroxyl group, a sulfone group and a carboxyalkyl group in the molecule of spectral sensitizing dye are desirable because their adsorption to the semiconductor can be fast. In addition, metal complexes are desirable because they can be excellent in their spectral sensitization effect and durability.

As the metal complex, metal phthalocyanines such as copper phthalocyanine and titanyl phthalocyanine; chlorophyll; hemin; and complexes of ruthenium, osmium, iron or zinc, can be employed.

As the organic dye, metal-free phthalocyanine, cyanine dyes, merocyanine dyes, xanthene dyes, and triphenylmethane dyes can be employed. Specific examples of the cyanine dyes include NK1194 and NK3422 (both from Japanese Res. Inst. for Photosensitizing Dyes Co., Ltd). Specific examples of the merocyanine dyes include NK2426 and NK2501 (both from Japanese Res. Inst. for Photosensitizing Dyes Co., Ltd). Specific examples of the xanthene dyes include uranine, eosine, rose bengal, rhodamine B and dibromofluorescein. Specific examples of the tripheynlmethane dyes include malachite green and crystal violet.

Further, examples of the dye include ruthenium complexes. In particular, one which is obtainable by substituting hydrophobic substituents, in particular aliphatic chains of tuned length, on the heterocyclic ligands of Ru is desirable. Among suitable dyes are compounds of formula RuLL′X2 (where L is 4,4′-di-carboxylic acid-2,2′-bipyridine, and L′ is 4,4′-di-alkyl-2,2′-bipyridine, in which, the alkyl substituent has a midsized chain length, in particular C₆ to C₂₀, and X is a halogen, H₂O, CN and amine, NCS or NCO).

In order to allow the organic dye (spectral sensitizing dye) to be adsorbed to the porous semiconductor layer 3, using a dye solution being prepared by dissolving the organic dye in water and/or an organic solvent, the transparent conductive base material 1 on which the porous semiconductor layer 3 is formed may be immersed with the organic dye in this dye solution at room temperature or under heating conditions. As the organic solvent, any of organic solvents which can dissolve the spectral sensitizing dye to use can be employed. Specific examples of such organic solvents include alcohols, toluene, dimethylformamide, chloroform, ethyl cellosolve, N-methylpyrrolidone, tetrahydrofuran and the like. A mixture of t-butanol/acetonitrile=1:1 can be suitably used.

A method for adsorption of the sensitizing dye on the porous semiconductor layer 3 is not particularly limited. Ordinary methods such as allowing the above-mentioned dye solution to be absorbed into the porous semiconductor layer 3 by dipping, spinning, spraying or the like, followed by drying, can be employed. The processes of absorption and drying may be repeated as necessary. Further, the photosensitizing dye may also be adsorbed to the porous semiconductor layer 3 by bringing the above-mentioned dye solution into contact with the porous semiconductor layer 3 while refluxing the dye solution by heating.

### (Counter Electrode)

FIG. 1B is a cross-sectional view showing a part of the counter electrode shown in FIG. 1A in an enlarged manner. The counter electrode 5, being a catalyst layer, is one which functions as a positive electrode of the dye-sensitized solar cell (photoelectric conversion element). The counter electrode 5 is a so-called carbon electrode, and contains carbon black 31, a fibrous carbon material 32 and an organic binder (not shown). The fibrous carbon material 32 is desirable to be dispersed in the counter electrode and forming an electrical path among the carbon black. Further, the dispersing of fibrous carbon allows formation of strong film as an electrode film, and thus, the electrical path can be maintained for a long time, and high durability can be obtained.

The mass ratio (B/A) of the carbon black (A) and the fibrous carbon material (B) is desirable to be within the range of from 10/90 to 50/50. If the mass ratio (B/A) is less than 10/90, the counter electrode 5 is prone to occurrence of cracks, and becomes more likely to cause separation of the counter electrode 5 from the transparent conductive base material 2. As a result, there is a possibility that the resistance of the counter electrode 5 is increased, and decrease in conversion efficiency may easily occur. On the other hand, if the mass ratio (B/A) exceeds 50/50, active sites of the carbon black which are catalytic sites would be reduced, and it may lower the reaction rate of a reduction reaction (for example, reduction reaction to reduce I₃⁻ to I⁻) to obtain a reductant by reacting electrons to an oxidant of the redox couple (for example, I₃⁻/I⁻) in the electrolyte.

Composition analysis of the counter electrode 5 can be made, for example, in the following manner. First, the counter electrode 5 is dipped in a solvent such as N-methylpyrrolidone, which solvent can fully dissolve the organic binder, so that the organic binder is dissolved. Upon this, the carbon material peels off from the substrate and the organic binder dissolves in a solvent. By filtering the resultant mixture to separate the solution in which the organic binder was dissolved, followed by evaporating the solution to dryness in a rotary evaporator or the like, an amount of residue as an amount of the organic binder can be measured. Further, the carbon material that has been separated is dispersed again in water, a mixture of organic solvents, or the like; and by centrifuging the resultant dispersion, the fibrous carbon material and the carbon black can be separated, so that each can be weighed, to eventually derive the composition ratio.

In addition, in the above-mentioned Japanese Patent Application Laid-open No. 2004-152747, a carbon electrode including carbon black-like particles, columnar conductive material particles and anatase-type titanium dioxide particles has been disclosed. Further, content of the carbon black-like particles (W1) and content of the columnar conductive material particles (W2) have been disclosed to be satisfying the condition represented by 0.05<(W1/W2)<0.4. However, regarding the counter electrode 5 of the present disclosure combining the carbon black 31, the fibrous carbon material 32 and the organic binder, even if the content of the carbon black 31 and the fibrous carbon material 32 each satisfies the above-mentioned condition as in Japanese Patent Application Laid-open No. 2004-152747, both the conversion efficiency and durability to be obtained are still low. Regarding the counter electrode of the present disclosure, high conversion efficiency and durability can be obtained only in cases where the mass ratio (B/A) is within the range of from 10/90 to 50/50.

It is not clear on the mechanism by which the good characteristics can be obtained when the mass ratio (B/A) is within the range of from 10/90 to 50/50 in the system using the organic binder, while the condition with large fibrous carbon material content has been desirable in a system using an inorganic binder. The present inventors speculate as follows. That is, the greater the content ratio of carbon black originally is, the more advantageous it can be for a redox reaction since there are many active sites, but on the other hand, it becomes “brittle” as a counter electrode, and thus electronic conductivity has been decreased. It is speculated that a carbon fiber material serves as a reinforcing agent in such a case, and thus high electronic conductivity was able to be retained. Further, regarding the system using the organic binder, it is speculated that the organic binder has reinforced adhesiveness by effectively covering the surface of the carbon black, and thus better characteristics was able to be retained in the condition with less content of carbon fiber.

### (Carbon Black)

The carbon black includes aggregates of primary particles aggregated together, for example. As the carbon black 31, one which has high electric conductivity is desirable. Further, the carbon black 31 is desirable to be one that can easily form a structured form. Examples of the carbon black 31 which can be employed include those in amorphous state; in crystallized state; and in a state that the amorphous and the crystallized ones are mixed; which may also be used in combination. Specific examples of the carbon black 31 include Ketjen Black, furnace black, lamp black, channel black, acetylene black, thermal black and the like. Among these, Ketjen Black, which is less expensive and having a large specific surface area may be suitable, but the carbon black is not limited thereto.

An average particle diameter of the primary particles of the carbon black 31 desirably is within the range of from 3 nm to 100 nm, more desirably from 5 nm to 80 nm, and still more desirably from 8 nm to 70 nm. The specific surface area of the carbon black 31 desirably is within the range of from 300 m²/g to 500 m²/g.

Surface pH of the carbon black desirably is within the range of from 6 to 9. That is, around neutral pH is desirable. It is not clearly known about the mechanism of why these phenomena occur in this pH range. However, it is currently thought to be as follows. At a pH value less than 6 or exceeding 9, the number of functional groups such as —OH, —COH and —COOH on the surface tends to be increased. Since a catalytic site is thought to be in a C—H site or C site, the increase in number of the functional groups can be considered undesirable because the number of such catalytic sites would be relatively decreased.

The surface pH of the carbon black can be measured in the following manner. A mixed solution including carbon black and distilled water is subjected to measurement using a glass electrode pH meter. In detail, it can be measured in accordance with JIS K5101-17, which is, by suspending the carbon black in water at room temperature or being boiled, and then by applying a test method such as one for measuring the pH of the aqueous suspension, with the use of a pH meter.

Further, as a method for extracting the carbon black from the counter electrode 5, the method as in the above-mentioned composition analysis of the counter electrode 5 can be employed.

### (Fibrous Carbon Material)

The fibrous carbon material is desirable to have high rigidity. This is because such a fibrous carbon material can be dispersed in the counter electrode, and can be forming an electrical path among the carbon black. As such a fibrous carbon material, a vapor-grown carbon fiber (VGCF) may desirably be employed. As a method for generating the vapor-grown carbon fiber, for example, a method by thermally decomposing hydrocarbons at 800° C. to 1300° C., using a particulate metal such as iron as a catalyst, can be employed. Other examples of methods for its generation include electrospinning methods for producing carbon fibers. An electrospinning method is a method in which a material solution is sprayed to form a fiber by applying high voltage to a nozzle. By using this method, a carbon fiber of about 200 nm can be obtained.

An average diameter of the base of columnar particles of the fibrous carbon material 32 is desirable to be within the range of from 50 nm to 500 nm. If the average diameter of the base is less than 50 nm, contact resistance between the particles may have larger influence on electronic conduction, so the electronic conductivity decreases, and there is a tendency that the above-mentioned advantageous effects may not be obtained. On the other hand, if the average diameter of the base exceeds 500 nm, internal paths in the counter electrode would be longer, so diffusion of oxidants and reductants may not be made immediately, and resistance may increase. Thus, there is a tendency that it leads to decrease in conversion efficiency.

An average height of the particles of the fibrous carbon material 32 is desirable to be within the range of from 1 μm to 20 μm. If the average height is less than 1 μm, the contact resistance may have larger influence on electronic conduction, so there is a tendency that the electronic conductivity decreases. On the other hand, if the average height exceeds 20 μm, it becomes more difficult to uniformly mix and disperse the columnar particles of the fibrous carbon material 32 and the other constituent materials, so there is a tendency that decrease in electronic conductivity and in mechanical strength is more likely to occur.

### (Organic Binder)

Basically, the organic binders may be any organic materials that are not likely to be damaged by the electrolyte, but are electrochemically stable and capable of binding carbons. Examples of the organic binders may include those having one or more selected from the group consisting of polyvinylidene fluoride, polytetrafluoroethylene, polyamide, polyamide-imide, aramid, polyacrylonitrile and polymethacrylonitrile.

The proportion ((N/M)×100) of the organic binder (N) with respect to the total amount of all the materials that make up the carbon counter electrode (M) is desirable to be within the range of from 0.5 mass % to 5.0 mass %. If the proportion ((N/M)×100) is less than 0.5 mass %, the binding force in the counter electrode 5 tends to be significantly lower. On the other hand, if the proportion ((N/M)×100) exceeds 5.0 mass %, the number of catalytic active sites would be decreased with the decrease of the carbon content in the counter electrode, so the catalytic effect on reduction reaction becomes diminished and the photoelectric conversion efficiency tends to be lower.

The thickness of the counter electrode 5 desirably is within the range of from 5 μm to 200 μm, more desirably from 5 μm to 100 μm, and still more desirably from 10 μm to 100 μm. If the thickness of the counter electrode 5 is less than 5 μm, the ability to reduce the redox species in the electrolyte solution that makes up the electrolyte layer 4 becomes diminished and the photoelectric conversion efficiency tends to be lower. On the other hand, if the thickness of the counter electrode 5 exceeds 200 μm, there is a tendency that electron transfer inside the counter electrode 5 is not made smoothly.

### (Conductive Powder)

The counter electrode 5 is desirable to be further including a conductive powder which is an electrically conductive auxiliary agent. This is because it can enhance the open-circuit voltage (Voc) and the fill factor (FF), in particular, among the characteristics of the dye-sensitized solar cell. It is not clear on the mechanism of enhancing the open-circuit voltage (Voc) and the fill factor (FF). However, among the resistance of the porous counter electrode 5, the contact resistance between the carbon particles is thought to be decreased, by that the conductive powder is contained. It can be thought that as a result, overvoltage is lowered and the open-circuit voltage (Voc) is increased.

As the conductive powder, a conductive powder having a powder resistivity of equal to or less than 10 mΩ may desirably be employed. As the conductive powder having a powder resistivity of equal to or less than 10 mΩ, one or more selected from the group consisting of ITO particulates, ZnO particulates and titanium hydride particles may desirably be employed. An average particle diameter of the conductive powder desirably is within the range of from 10 nm to 1 μm, and more desirably, from 20 nm to 500 nm. If the average particle diameter is too large, the counter electrode 5 is prone to occurrence of cracks, and there is a possibility that the counter electrode 5 would be peeled off from the transparent conductive base material 2. Examples of powder shapes of the conductive powder include spherical, ovoid, cube-shaped, rectangular parallelepiped, cylindrical or rod-shaped, and other various shapes, but are not limited to these shapes.

The proportion ((L/M)×100) of the conductive powder (L) with respect to the total amount of all the materials that make up the counter electrode 5 (M) may be within the range of from 0.5 mass % to 20 mass %, and more desirably, from 1 mass % to 10 mass %. If the proportion ((L/M)×100) is less than 0.5 mass %, there is a tendency that the effect of the conductive powder is less likely to appear. On the other hand, if the proportion ((L/M)×100) exceeds 20 mass %, the amount of the carbon black having catalytic sites is relatively decreased. As a result, the resistance becomes higher. The fill factor becomes lower, so the conversion efficiency tends to be lower.

### (Basic Oxide)

The counter electrode 5 is desirable to be further including a basic oxide. As the basic oxide, hydrotalcite particulates, which are a composite oxide, may desirably be employed. This is because it can enhance the open-circuit voltage (Voc), in particular, among the characteristics of the dye-sensitized solar cell. It is not clear on the mechanism of enhancing the open-circuit voltage (Voc). However, it can be thought that as the oxidation-reduction between the carbon and a redox mediator can be made smoothly, resistance therebetween can be reduced, and as a result, overvoltage is lowered and the open-circuit voltage (Voc) is increased.

The hydrotalcite particulates are desirable to be containing magnesium as the main component. This is because it can improve stability and impurity adsorption capacity. Further, the hydrotalcite particulates are desirable to be those having high surface activity with high-specific surface area, in which adsorbed water is reduced. This is because it can adsorb very well the moisture, free dyes, impurities and the like in the cell, and thus an improvement in durability can be expected in storage tests and the like.

The specific surface area of the hydrotalcite particulates is desirable to be as large as possible. Specifically, the surface area by the BET method desirably is within the range of not less than 10 m²/g, and more desirably, not less than 30 m²/g. An average particle diameter of such hydrotalcite particulates desirably is within the range of from 1 nm to 10 μm, and more desirably, from 10 nm to 5 μm.

In addition, examples of shapes of the hydrotalcite particulates which can be employed include spherical, ovoid, cube-shaped, rectangular parallelepiped, cylindrical or rod-shaped, and other various shapes, but are not limited to these shapes. Specific examples of the hydrotalcite include Kyowaad (by Kyowa Chemical Industry Co., Ltd.) and the like. Among them, a hydrotalcite that has a composite oxide of magnesium and aluminum (Kyowaad (KW) 2000, 2200 or the like) is desirable because it can be excellent in terms of stability and impurity adsorption capacity.

The proportion ((K/M)×100) of the hydrotalcite (K) with respect to the total amount of all the materials that make up the counter electrode 5 (M) may be within the range of from 0.5 mass % to 20 mass %, and more desirably, from 1 mass % to 10 mass %. If the proportion ((K/M)×100) is less than 0.5 mass %, there is a tendency that the effect of the hydrotalcite particulates is less likely to appear. On the other hand, if the proportion ((K/M)×100) exceeds 20 mass %, there is a tendency that reaction resistance increases because hydrotalcite particulates are an insulating material and may cause the conductive path to be blocked.

### (Hydrophobic Silica Particles)

The counter electrode 5 is desirable to be further including hydrophobic silica particles. This is because it can enhance the short-circuit current (Jsc) and the open-circuit voltage (Voc), in particular, among the characteristics of the dye-sensitized solar cell. It is not clear on the mechanism by which the short-circuit current (Jsc) and the open-circuit voltage (Voc) can be enhanced, but it can be thought as follows. The carbon black 31 alone tends to agglomerate easily in the preparation of the counter electrode 5 including the carbon black 31 and the fibrous carbon material 32. In the presence of the hydrophobic silica particles having a particle diameter about the same as this carbon black 31, the carbon black 31 becomes less likely to agglomerate, in the paste and in the coating and drying processes, which becomes more highly dispersed. It can be thought that as a result, the contact area with the electrolyte solution becomes larger and thus efficiency of redox between carbon and iodine is increased. In addition, as there is an effect of hydrophobicity, it is less likely to adsorb moisture, so this may also serve to prevent deterioration due to moisture adsorption of the counter electrode 5 and thus an improvement in durability can be expected in storage tests and the like.

The hydrophobic silica particles are silica particles which are not wetted by water. Silanol groups of the surfaces of the hydrophobic silica particles are desirable to be alkylated by alkyl groups. The alkyl groups desirably are those of 18 or less carbon atoms, more desirably 4 or less carbon atoms, and still more desirably a methyl group.

As a method for producing the hydrophobic silica particles, they can be obtained by mixing hydrophilic silica particles with silanes (for example, halosilanes, alkoxysilanes, silazanes or siloxanes). Examples of desirable silanes used in the production of hexamethyldisilazane include dimethyldichlorosilane. The appropriate hydrophobic silicas may be derived from precipitated, colloidal, precompacted or pyrogenic silicas, in which, the pyrogenic silicas may be desirable.

For example, reaction of hydrophilic silica with dimethyldichlorosilane results in hydrophobic Aerosil having the proprietary name “Aerosil (registered trademark) R972”. This has a degree of methylation of 66%-75% (determined by titration of the remaining silanol groups).

The proportion ((J/M)×100) of the hydrophobic silica particles (J) with respect to the total amount of all the materials that make up the counter electrode 5 (M) desirably is within the range of from 0.1 mass % to 20 mass %, and more desirably, from 1 mass % to 10 mass %. If the proportion ((J/M)×100) is less than 0.1 mass %, there is a tendency that the effect of the hydrophobic silica particles is less likely to appear. On the other hand, if the proportion ((J/M)×100) exceeds 20 mass %, there is a tendency that reaction resistance increases because hydrophobic silica particles are an insulating material and may cause the conductive path to be blocked.

### (Electrolyte Layer)

For making up the electrolyte layer 4, typically an electrolyte solution may be used. As the electrolyte solution, a known one can be employed, and may be selected as necessary. From the viewpoint of preventing volatilization of the electrolyte solution, suitably, a low-volatile electrolyte solution, for example, an ionic liquid-based electrolyte solution using an ionic liquid as a solvent may be employed. As the ionic liquid, a known one can be employed, and may be selected as necessary.

As mediators (redox substances) of the electrolyte solution, iodine has been widely known from the past.

However, this can be other mediators as well. Examples of the mediators include Co complexes and Ni complexes.

Examples of the Co complexes include Co(II/III)tris(bipyridyl) (Science 4 Nov. 2011: Vol. 334 no. 6056 pp. 629-634).

Examples of the Ni complexes include boron-functionalized Ni(III/IV)-bis(dicarbollide) clusters (Angewandte Chemie International Edition. Volume 49, Issue 31, pages 5339-5343, Jul. 19, 2010).

Iodine is generally known to be highly corrosive, thus, in the configuration of dye-sensitized solar cells, it has been necessary to use a material that is highly iodine-resistant as parts that may be in contact with the electrolyte solution. However, as for Co complexes and Ni complexes, since such corrosiveness is lower, it makes possible to employ inexpensive materials as the parts that make up the cell, and thus may reduce costs.

Further, a gel electrolyte or a solid electrolyte can be used as well. The gel electrolyte may include a polymer forming a polymer matrix, for example. The polymer matrix provides a beneficial physical state to the electrolyte, that is, a solid state, a quasi-solid state, a rubber-like state or a gel state. Examples of the polymers can be those selected from polyvinylidene fluoride (PVDF), polyvinylidene fluoride-hexafluoropropylene (PVDF-HFP), polyvinylidene fluoride-hexafluoropropylene-chlorotrifluoroethylene (PVDF-HFP-CTFE) copolymers, polyethylene oxide, polymethylmethacrylate, polyacrylonitrile, polypropylene, polystyrene, polybutadiene, polyethyleneglycol, polyvinylpyrrolidone, polyaniline, polypyrrole, polythiophene and their derivatives. Examples of desirable polymers include polyvinylidene fluoride-hexafluoropropylene copolymers (PVDF-HFP) and the like.

The electrolyte may also include, as a gelling compound, a metal oxide in form of nanoparticles capable of forming a gel matrix. Such a gel matrix provides a beneficial physical state to the electrolyte, that is, a solid state, a quasi-solid state or a gel state. Examples of the metal oxides which can be used include SiO₂, TiO₂, Al₂O₃, MgO, TiO₂ nanotubes and TiO₂ nanorods. The gel may contain the nanoparticles in minor proportions, in which, the range of from 2 to 20 wt % of the electrolyte may be desirable. Examples of desirable gelling compounds include SiO₂ or TiO₂ nanoparticles.

### [3. Method for Manufacturing Dye-Sensitized Solar Cell]

Next, an example of a method for manufacturing the dye-sensitized solar cell according to an embodiment of the present disclosure will be described.

### (Formation of Counter Electrode)

First, the carbon black, the fibrous carbon material and the organic binder are mixed. Subsequently, by adding a solvent to the resultant mixed powder, a slurry is prepared. As the solvent, an organic solvent such as N-methylpyrrolidone can be employed, for example. Next, by coating the prepared slurry onto the transparent conductive layer 22 of the transparent conductive base material 2, followed by drying by heating, the counter electrode 5 is prepared on the surface of the transparent conductive base material 2.

### (Formation of Porous Semiconductor Layer)

Next, the porous semiconductor layer 3 is formed onto the transparent conductive layer 12 of the transparent conductive base material 1. In the following, a process of forming the porous semiconductor layer 3 will be described in detail.

First, the metal oxide semiconductor particulates are dispersed in a solvent to prepare a paste which is a composition for forming a porous semiconductor layer. A binder, as necessary, can be additionally dispersed in the solvent. In preparing the paste, hydrothermally synthesized monodispersed colloidal particles may be used as necessary. Examples of the solvents include lower alcohols having a carbon number of 4 or less such as methanol, ethanol, isopropanol, sec-butanol and t-butanol; aliphatic glycols such as ethylene glycol, propylene glycol (1,2-propanediol), 1,3-propanediol, 1,4-butanediol, 1,2-butanediol, 1,3-butanediol and 2-methyl-1,3-propanediol; ketones such as methyl ethyl ketone; amines such as dimethyl ethyl amine; and the like, which can be used individually or in combination of two or more thereof, but are not particularly limited thereto. As a dispersion method, a known one can be employed. Specific examples of the dispersion methods which can be employed include, but are not particularly limited to, stirring, ultrasonic dispersion, bead dispersion, kneading, homogenizer processing and the like.

Next, after coating or printing the prepared paste onto the transparent conductive layer 12, by drying the paste, the solvent is evaporated. As a result, the porous semiconductor layer 3 is formed onto the transparent conductive layer 12. The drying conditions are not particularly limited but may either be natural drying or artificial drying such that the drying temperature and drying time are adjusted. In cases where artificial drying is employed, the drying temperature and drying time are desirable to be set within the range in which the base material 11 does not deteriorate, taking into account the heat resistance of the base material 11. As a coating method or printing method, one which is convenient and is suitable in mass productivity may desirably be employed. Examples of the coating methods which can be used include, but are not particularly limited to, a micro gravure coating method, a wire-bar coating method, a direct gravure coating method, a die coating method, a dipping method, a spray coating method, a reverse roll coating method, a curtain coating method, a comma coating method, a knife coating method, a spin coating method, and the like. Examples of the printing methods which can be used include, but are not particularly limited to, relief printing, offset printing, gravure printing, intaglio printing, rubber plate printing, screen printing, and the like.

### (Baking)

Subsequently, the thus-prepared porous semiconductor layer 3 is baked to improve electronic connections between the metal oxide semiconductor particulates in the porous semiconductor layer 3. The baking temperature desirably may be in the temperature range of from 40 to 1000° C., and more desirably about from 40 to 600° C., but is not particularly limited thereto. Further, the baking time may be in the time range of about from 30 seconds to 10 hours, but is not particularly limited thereto.

### (Supporting of Dye)

Next, the sensitizing dye is dissolved in a solvent to prepare a solution. In order to dissolve the sensitizing dye, heating, addition of solubilizing agent and filtration of insoluble matter may also be performed. The solvent is desirable to be one that is capable of dissolving the sensitizing dye as well as mediating adsorption of the dye to the porous semiconductor layer 3. Examples of such solvents include alcohol solvents such as ethanol, isopropyl alcohol and benzyl alcohol; nitrile solvents such as acetonitrile and propionitrile; halogen solvents such as chloroform, dichloromethane and chlorobenzene; ether solvents such as diethyl ether and tetrahydrofuran; ester solvents such as ethyl acetate and butyl acetate; ketone solvents such as acetone, methyl ethyl ketone and cyclohexanone; carbonic acid ester solvents such as diethyl carbonate and propylene carbonate; hydrocarbon-based solvents such as hexane, octane, toluene and xylene; dimethyl formamide; dimethyl acetamide; dimethyl sulfoxide; 1,3-dimethyl imidazolinone; N-methylpyrrolidone; water; and the like, which can be used individually or in combination of two or more thereof, but are not limited thereto.

Subsequently, for example, by dipping the porous semiconductor layer 3 into the prepared solution including the sensitized dye, it allows the metal oxide semiconductor particles to support the sensitizing dye.

### (Filling of Electrolyte)

Then, after forming a UV-curing type adhesive as the sealing material 6 at the peripheral part of the transparent conductive layer 22 of the transparent conductive base material 2 by screen printing, the transparent conductive base material 1 is bonded to this, mediated by the UV-curing type adhesive. At this time, the porous semiconductor layer 3 and the counter electrode 5 are disposed opposite one another, with a predetermined distance therebetween, which distance is, for example, from 1 to 100 μm, and desirably from 1 to 50 μm. This allows the transparent conductive base materials 1 and 2 and the sealing material 6 to form a space in which the electrolyte layer 4 can be filled. Subsequently, to this space, for example, by injecting the electrolyte from an inlet which has been formed in advance to the transparent conductive base material 2, the electrolyte layer 4 is filled inside the space. After this, this inlet is closed. Thus, the intended dye-sensitized solar cell is manufactured.

### [4. Operation of Dye-Sensitized Solar Cell]

Next, an operation of the dye-sensitized solar cell according to an embodiment of the present disclosure will be described.

The dye-sensitized solar cell is configured to operate as a battery using the counter electrode 5 as a positive electrode and the transparent conductive layer 12 as a negative electrode, when light L is incident on the light receiving surface of the transparent conductive base material 1. The principle of this operation is as follows.

When photons transmitted the base material 11 and the transparent conductive layer 12 are absorbed by a photosensitizing dye, the electrons contained in the photosensitizing dye are excited from a ground state (HOMO) to an excited state (LUMO). The electrons in an excited state are extracted to a conduction band of the porous semiconductor layer 3 via an electric bond between the photosensitizing dye and the porous semiconductor layer 3, and reach the transparent conductive layer 12 through the porous semiconductor layer 3.

Meanwhile, the photosensitizing dye after losing the electrons receives electrons from a reducing agent in the electrolyte layer 4, for example, from I⁻ by the following reaction, and produces an oxidizing agent, for example, I₃⁻ (binding product of I₂ and I⁻), in the electrolyte layer 4.

2I⁻→I₂+2e⁻

I₂+I⁻→I₃⁻

The produced oxidizing agent, for example, I₃⁻, reaches the counter electrode 5 by diffusion, and then by the following reaction (reverse reaction of the above-described reaction), it receives the electrons from the counter electrode 5 and is reduced to become the original reducing agent, for example, I⁻.

I₃⁻→I₂+I⁻

I₂+2e⁻→2I⁻

The electrons transferred from the transparent conductive layer 12 to an external circuit complete an electric work in the external circuit and are brought back to the counter electrode 5. In such a manner, the photon energy is converted into the electric energy without leaving any change in the photosensitizing dye or in the electrolyte layer 4.

### (Effects)

According to this embodiment, the counter electrode 5 includes the carbon black, the fibrous carbon material and the organic binder, and the carbon black (A) and the fibrous carbon material (B) are in a mass ratio (B/A) within the range of from 10/90 to 50/50. Thus, it can provide an electrode which is excellent in conversion efficiency and durability, and can provide a photoelectric conversion element including such an electrode.

### EXAMPLES

The present disclosure will now be described by way of examples thereof. It should be noted that the present disclosure is not restricted to the examples below.

Examples of the present disclosure will be described in the following order.

1. Preparation of dye-sensitized solar cell
1-1. Type of material of carbon counter electrode
1-2. Mass ratio of carbon black and vapor-grown carbon fiber (binder: PVDF)
1-3. Proportion of PVDF
1-4. Mass ratio of carbon black and vapor-grown carbon fiber (binder: PAI)
1-5. Thickness of carbon counter electrode
1-6. Specific surface area of carbon black
1-7. Amount of addition of ITO particles
1-8. Amount of addition of hydrotalcite
1-9. Addition of hydrophobic silica particles
1-10. Amount of addition of CNT
1-11. Surface pH of carbon black
1-12. Cell in which electrolyte solution using Co complex mediator is employed
   2. Method for evaluation of dye-sensitized solar cell
   3. Evaluation results of dye-sensitized solar cell
3-1. Evaluation results of type of material of carbon counter electrode
3-2. Evaluation results of mass ratio of carbon black and vapor-grown carbon fiber (binder: PVDF)
3-3. Evaluation results of proportion of PVDF
3-4. Evaluation results of mass ratio of carbon black and vapor-grown carbon fiber (binder: PAI)
3-5. Evaluation results of thickness of carbon counter electrode
3-6. Evaluation results of specific surface area of carbon black
3-7. Evaluation results of amount of addition of ITO particles
3-8. Evaluation results of amount of addition of hydrotalcite
3-9. Evaluation results of addition of hydrophobic silica particles
3-10. Evaluation results of amount of addition of CNT
3-11. Evaluation results of surface pH of carbon black
3-12. Cell in which electrolyte solution using Co complex mediator is employed

### I. Preparation of Dye-Sensitized Solar Cell

### 1-1. Type of Material of Carbon Counter Electrode

### Example 1-1

### Preparation of Carbon Counter Electrode

First, carbon black (from Mitsubishi Chemical Corporation, product name: #2600), a vapor-grown carbon fiber (VGCF) (from Showa Denko KK) and a polyvinylidene fluoride (PVdF) (by Kureha Chemical Co., Ltd., product name: #7300) were thoroughly mixed in a powder state. At this time, the mixing ratio of each material was adjusted such that the mass ratio (B/A) of the carbon black (A) and the vapor-grown carbon fiber (B) is 25/75, and the proportion ((N/M)×100) of the polyvinylidene fluoride (N) with respect to the total amount of all the materials that make up a carbon counter electrode (M) is 2 mass %. In this context, all the materials that make up the carbon counter electrode are the carbon black, the vapor-grown carbon fiber and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate (1.0t) using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 36 μm.

### [Preparation of Porous Titania Layer]

First, a FTO film was formed onto the surface of a glass substrate by CVD. The glass substrate on which the FTO film was formed was immersed in a TiCl₄ solution at a temperature of 70° C. for 40 minutes. Subsequently, the FTO film was dried, and thus a thin film of TiO₂ was formed onto the surface of the FTO film. Next, the FTO layer was coated with titanium oxide paste (PST-24NRT, from Catalysts & Chemicals Ind. Co., Ltd.) by screen printing, followed by coating titanium oxide paste (PST-200C, from Catalysts & Chemicals Ind. Co., Ltd.), and thus a porous titania layer having an outer diameter of 5 mmφ and a thickness of 17 μm was formed. By keeping the resultant porous titania layer at a temperature of 500° C. for 30 minutes, a porous titania counter electrode was obtained. The obtained porous titania counter electrode was immersed in a TiCl₄ solution, and was kept at a temperature of 70° C. for 40 minutes. Subsequently, the porous titania counter electrode was dried, followed by an additional atmospheric baking at a temperature of 500° C. for 30 minutes, and thus the intended porous titania counter electrode was prepared.

Next, 2991, as a photosensitizing dye, was allowed to be adsorbed to the prepared porous titania counter electrode in the following manner. First, a mixed solvent was prepared by mixing acetonitrile and tert-butanol at a volume ratio of acetonitrile:tert-butanol=1:1. Further, to the prepared mixed solvent, 2991 as a photosensitizing dye and DPA (1-decylphosphonic acid) as a co-adsorbent were mixed at a molar ratio of Z991:DPA=4:1 and were dissolved. Thus, a dye solution was prepared. Subsequently, by keeping the prepared porous titania counter electrode immersed in the dye solution at room temperature for 40 hours, the surface of the porous titania counter electrode was allowed to support the photosensitizing dye. Then, the porous titania counter electrode was rinsed with acetonitrile, followed by evaporating the solvent therefrom in a dark place, and the porous titania counter electrode was dried.

### [Preparation of Dye-Sensitized Solar Cell]

Subsequently, the thus-prepared porous titania counter electrode and the carbon counter electrode were disposed opposite one another, and their outer periphery was sealed with an epoxy-based UV-curable resin which includes a 60 μm spacer.

Next, as an electrolyte, an electrolyte solution, in which LiI (0.05 mol/l), methoxypropioimidazolium iodide (1.0 mol/l), iodine (I₂) (0.10 mol/l) and 1-butylbenzimidazole (NBB) (0.25 mol/l) are dissolved in methoxypropionitrile, was prepared.

Subsequently, this electrolyte solution was injected with a tubing pump from an inlet of a dye-sensitized solar cell, which has been formed in advance, and air bubbles inside the cell were drove out by reducing the pressure. Then, the inlet was sealed with an epoxy-based UV-curable resin, and thus the dye-sensitized solar cell was completed.

### Comparative Example 1-1

A dye-sensitized solar cell was prepared as in Example 1-1 except that an activated carbon (from Kuraray Co., Ltd., product name: YP-80F) was used in place of the vapor-grown carbon fiber.

### Comparative Example 1-2

A dye-sensitized solar cell was prepared as in Example 1-1 except that graphite (mesocarbon microbeads (MCMB)) (from JFE Steel Corporation, product name: SYG-D3) was used in place of the vapor-grown carbon fiber.

### Comparative Example 1-3

A dye-sensitized solar cell was prepared as in Example 1-1 except that a Pt/Ti counter electrode in which a 100-nm platinum film was formed onto the surface of the Ti plate (1.0t) by sputtering was used.

### 1-2. Mass Ratio of Carbon Black and Vapor-Grown Carbon Fiber (Binder: PVDF)

### Examples 2-1 to 2-8

Dye-sensitized solar cells were prepared as in Example 1-1 except that the mass ratio (B/A) of the carbon black (A) and the vapor-grown carbon fiber (B) was altered to the value shown in Table 2.

### 1-3. Proportion of PVDF

### Examples 3-1 to 3-6

Dye-sensitized solar cells were prepared as in Example 1-1 except that the proportion ((N/M)×100) of the polyvinylidene fluoride (N) with respect to the total amount of all the materials that make up a carbon counter electrode (M) was altered as shown in Table 3, with the mass ratio (B/A) of the carbon black (A) and the vapor-grown carbon fiber (B) being fixed at 25/75.

### 1-4. Mass Ratio of Carbon Black and Vapor-Grown Carbon Fiber (Binder: PAI)

### Examples 4-1 to 4-5

The mass ratio (B/A) of the carbon black (A) and the vapor-grown carbon fiber (B) was altered as shown in Table 4. Further, a polyamide-imide (from Toyobo Co., Ltd., product name: Vylomax) was used as the organic binder in place of the polyvinylidene fluoride. Dye-sensitized solar cells were prepared in the same manner as in Example 1-1 except these conditions.

### 1-5. Thickness of Carbon Counter Electrode

### Examples 5-1 to 5-4

Dye-sensitized solar cells were prepared as in Example 1-1 except that the thickness of the carbon counter electrode was altered as shown in Table 5.

### 1-6. Specific Surface Area of Carbon Black

### Examples 6-1 to 6-4

Dye-sensitized solar cells were prepared as in Example 1-1 except that carbon black having the BET specific surface area shown in Table 6 was employed as the carbon black.

### 1-7. Amount of Addition of ITO Particles

### Example 7-1

### Preparation of Carbon Counter Electrode

First, the carbon black (from Mitsubishi Chemical Corporation, product name: #2600), the vapor-grown carbon fiber (VGCF) (from Showa Denko KK), ITO particles (from Furuuchi Chemical Corporation: of average particle diameter of 30 nm, purity of 99.5%) and the polyvinylidene fluoride (PVdF) (by Kureha Chemical Co., Ltd., product name: #7300) were thoroughly mixed in a powder state. At this time, the mixing ratio of the carbon black (A) and the vapor-grown carbon fiber (B) was adjusted such that the mass ratio (B/A) thereof is 25/75. Further, the mixing ratio of each material was adjusted such that with respect to the total amount of all the materials that make up a carbon counter electrode (M), the proportion ((L/M)×100) of the ITO particles (L) is 8 mass % and the proportion ((N/M)×100) of the polyvinylidene fluoride (N) is 3 mass %. In this context, all the materials that make up the carbon counter electrode are the carbon black, the vapor-grown carbon fiber, the ITO particles and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 38 μm.

A dye-sensitized solar cell was prepared in the same manner as in Example 1-1 except the above-described process of preparation of the carbon counter electrode.

### Examples 7-2 and 7-3

Dye-sensitized solar cells were prepared as in Example 7-1 except that the proportion ((L/M)×100) of the ITO particles (L) with respect to the total amount of all the materials that make up a carbon counter electrode (M) was altered as shown in Table 7.

### 1-8. Amount of Addition of Hydrotalcite

### Example 8-1

### Preparation of Carbon Counter Electrode

First, the carbon black (from Mitsubishi Chemical Corporation, product name: #2600), the vapor-grown carbon fiber (VGCF) (from Showa Denko KK), a hydrotalcite (from Industry Co., Ltd.: DHT-4A: structural formula Mg₆Al₂(OH)₁₆CO₃.4H₂O) and the polyvinylidene fluoride (PVdF) (by Kureha Chemical Co., Ltd., product name: #7300) were thoroughly mixed in a powder state. At this time, the mixing ratio of the carbon black (A) and the vapor-grown carbon fiber (B) was adjusted such that the mass ratio (B/A) thereof is 25/75. Further, the mixing ratio of each material was adjusted such that with respect to the total amount of all the materials that make up a carbon counter electrode (M), the proportion ((K/M)×100) of the hydrotalcite (K) is 0.1 mass % and the proportion ((N/M)×100) of the polyvinylidene fluoride (N) is 2 mass %. In this context, all the materials that make up the carbon counter electrode are the carbon black, the vapor-grown carbon fiber, the hydrotalcite and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 35 μm.

A dye-sensitized solar cell was prepared in the same manner as in Example 1-1 except the above-described process of preparation of the carbon counter electrode.

### Examples 8-2 to 8-5

Dye-sensitized solar cells were prepared as in Example 8-1 except that the proportion ((K/M)×100) of the hydrotalcite (K) with respect to the total amount of all the materials that make up a carbon counter electrode (M) was altered as shown in Table 8.

### Example 8-6

A dye-sensitized solar cell was prepared as in Example 8-4 except that Mg₆Al₂(OH)₁₆NO₃.nH₂O which is a composition in which the counter ions of DHT-4A have been substituted by NO₃⁻ was employed as the hydrotalcite.

### 1-9. Addition of Hydrophobic Silica Particles

### Example 9-1

### Preparation of Carbon Counter Electrode

First, the carbon black (from Mitsubishi Chemical Corporation, product name: #2600), the vapor-grown carbon fiber (VGCF) (from Showa Denko KK), surface-modified hydrophobic silica particles (from Nippon Aerosil Co., Ltd., product name: R805) and the polyvinylidene fluoride (PVdF) (by Kureha Chemical Co., Ltd., product name: #7300) were thoroughly mixed in a powder state. At this time, the mixing ratio of the carbon black (A) and the vapor-grown carbon fiber (B) was adjusted such that the mass ratio (B/A) thereof is 25/75. Further, the mixing ratio of each material was adjusted such that with respect to the total amount of all the materials that make up a carbon counter electrode (M), the proportion ((J/M)×100) of the hydrophobic silica particles (J) is 3 mass % and the proportion ((N/M)×100) of the polyvinylidene fluoride (N) is 2 mass %. In this context, all the materials that make up the carbon counter electrode are the carbon black, the vapor-grown carbon fiber, the hydrophobic silica particles and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 36 μm.

A dye-sensitized solar cell was prepared in the same manner as in Example 1-1 except the above-described process of preparation of the carbon counter electrode.

### Example 9-2

A dye-sensitized solar cell was prepared as in Example 9-1 except that the proportion ((J/M)×100) of the hydrophobic silica particles (J) with respect to the total amount of all the materials that make up a carbon counter electrode (M) was 5 mass %.

### Example 9-3

A dye-sensitized solar cell was prepared as in Example 9-2 except that hydrophobic silica particles (from Nippon Aerosil Co., Ltd., product name: R202) that have undergone a hydrophobic treatment with dimethyl silicone oil were employed as the hydrophobic silica particles.

### Example 9-4

A dye-sensitized solar cell was prepared as in Example 9-2 except that hydrophobic silica particles (from Nippon Aerosil Co., Ltd., product name: RX200) that have undergone a hydrophobic treatment with a trimethylsilyl group were employed as the hydrophobic silica particles.

### Example 9-5

A dye-sensitized solar cell was prepared as in Example 9-2 except that hydrophobic silica particles (from Nippon Aerosil Co., Ltd., product name: RX200) that have undergone a hydrophobic treatment with a methyl group were employed as the hydrophobic silica particles.

### Example 9-6

A dye-sensitized solar cell was prepared as in Example 9-2 except that hydrophilic silica particles without surface-modification were used in place of the hydrophobic silica particles.

### 1-10. Amount of Addition of CNT

### Comparative Example 10-1

Without addition of vapor-grown carbon fiber (VGCF) (from Showa Denko KK), the carbon black (from Mitsubishi Chemical Corporation, product name: #2600) and the polyvinylidene fluoride (PVdF) (by Kureha Chemical Co., Ltd., product name: #7300) were thoroughly mixed in a powder state. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 32 μm.

A dye-sensitized solar cell was prepared in the same manner as in Example 1-1 except the above-described process of preparation of the carbon counter electrode.

### Example 10-1

### Preparation of Carbon Counter Electrode

First, the carbon black (from Mitsubishi Chemical Corporation, product name: #2600), multi-walled carbon nanotubes (MWCNT) and the polyvinylidene fluoride (PVdF) (by Kureha Chemical Co., Ltd., product name: #7300) were thoroughly mixed in a powder state. At this time, the mixing ratio of the carbon black (A) and the multi-walled carbon nanotubes (B) was adjusted such that the mass ratio (B/A) thereof is 1/99. Further, the mixing ratio of each material was adjusted such that the proportion ((N/M)×100) of the polyvinylidene fluoride (N) with respect to the total amount of all the materials that make up a carbon counter electrode (M) is 3 mass %. In this context, all the materials that make up the carbon counter electrode are the carbon black, the multi-walled carbon nanotubes and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 31 μm.

A dye-sensitized solar cell was prepared in the same manner as in Example 1-1 except the above-described process of preparation of the carbon counter electrode.

### Examples 10-2 and 10-3

Dye-sensitized solar cells were prepared as in Example 10-1 except that the mass ratio (B/A) of the carbon black (A) and the vapor-grown carbon fiber (B) was altered as shown in Table 11.

### 1-11. Surface pH of Carbon Black

### Example 11-1

### Preparation of Carbon Counter Electrode

First, carbon black having a BET specific surface area of 300 m²/g and a surface pH of 8 (from Mitsubishi Chemical Corporation, product name: #2300), the vapor-grown carbon fiber (VGCF) (from Showa Denko KK) and the polyvinylidene fluoride (PVdF) (by Kureha Chemical Co., Ltd., product name: #7300) were thoroughly mixed in a powder state. At this time, the mixing ratio of the carbon black (A) and the vapor-grown carbon fiber (B) was adjusted such that the mass ratio (B/A) thereof is 23/77. Further, the mixing ratio of each material was adjusted such that the proportion ((N/M)×100) of the polyvinylidene fluoride (N) with respect to the total amount of all the materials that make up a carbon counter electrode (M) is 3 mass %. In this context, all the materials that make up the carbon counter electrode are the carbon black, the vapor-grown carbon fiber and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 32 μm.

A dye-sensitized solar cell was prepared in the same manner as in Example 1-1 except the above-described process of preparation of the carbon counter electrode.

### Example 11-2

A dye-sensitized solar cell was prepared as in Example 11-1 except that carbon black having a BET specific surface area of 300 m²/g and a surface pH of 2.5 (from Mitsubishi Chemical Corporation, product name: #2350) was used.

### Example 11-3

A dye-sensitized solar cell was prepared as in Example 11-1 except that carbon black having a BET specific surface area of 370 m²/g and a surface pH of 6.5 (from Mitsubishi Chemical Corporation, product name: #2600) was used as carbon black in which the surface has undergone a reduction treatment.

### Example 11-4

A dye-sensitized solar cell was prepared as in Example 11-1 except that carbon black having a BET specific surface area of 370 m²/g and a surface pH of 3.0 (from Mitsubishi Chemical Corporation, product name: #2650) was used as carbon black in which the surface has undergone a reduction treatment.

### 1-12. Cell in which Electrolyte Solution Using Co Complex Mediator is Employed

### Example 12-1

### Preparation of Carbon Counter Electrode

First, the carbon black (from Mitsubishi Chemical Corporation, product name: #2600), the vapor-grown carbon fiber (VGCF) (from Showa Denko KK) and the polyvinylidene fluoride (PVdF) (by Kureha Chemical Co., Ltd., product name: #7300) were thoroughly mixed in a powder state. At this time, the mixing ratio of each material was adjusted such that the mass ratio (B/A) of the carbon black (A) and the vapor-grown carbon fiber (B) is 25/75, and the proportion ((N/M)×100) of the polyvinylidene fluoride (N) with respect to the total amount of all the materials that make up a carbon counter electrode (M) is 2 mass %. In this context, all the materials that make up the carbon counter electrode are the carbon black, the vapor-grown carbon fiber and the polyvinylidene fluoride. Subsequently, by further adding N-methylpyrrolidone to this mixed powder, followed by stirring the resultant mixture with a paint shaker, a carbon slurry was prepared.

Next, by coating the prepared carbon slurry onto the surface of a Ti substrate using an automatic coating machine and a knife coater, followed by drying at a temperature of 100° C. for 10 minutes using a far-infrared heating furnace, the carbon counter electrode was prepared at the surface of the Ti substrate. The thickness of the prepared carbon counter electrode was 28 μm.

### [Preparation of Porous Titania Layer]

First, a FTO film was formed onto the surface of a glass substrate by CVD. The glass substrate on which the FTO film was formed was immersed in a TiCl₄ solution at a temperature of 70° C. for 40 minutes. Subsequently, the FTO film was dried, and thus a thin film of TiO₂ was formed onto the surface of the FTO film. Next, the FTO layer was coated with the titanium oxide paste (PST-24NRT, from Catalysts & Chemicals Ind. Co., Ltd.) by screen printing, followed by coating the titanium oxide paste (PST-200C, from Catalysts & Chemicals Ind. Co., Ltd.), and thus a porous titania layer having an outer diameter of 5 mmφ and a thickness of 8 μm was formed. By keeping the resultant porous titania layer at a temperature of 500° C. for 30 minutes, a porous titania counter electrode was obtained. The obtained porous titania counter electrode was immersed in a TiCl₄ solution, and was kept at a temperature of 70° C. for 40 minutes. Subsequently, the porous titania counter electrode was dried, followed by an additional atmospheric baking at a temperature of 500° C. for 30 minutes, and thus the intended porous titania counter electrode was prepared.

Next, 2991, as a photosensitizing dye, was allowed to be adsorbed to the prepared porous titania counter electrode in the following manner. First, a mixed solvent was prepared by mixing acetonitrile and tert-butanol at a volume ratio of acetonitrile:tert-butanol=1:1. Further, to the prepared mixed solvent, Z991 as a photosensitizing dye and DPA (1-decylphosphonic acid) as a co-adsorbent were mixed at a molar ratio of Z991:DPA=4:1 and were dissolved. Thus, a dye solution was prepared.

Subsequently, by keeping the prepared porous titania counter electrode immersed in the dye solution at room temperature for 40 hours, the surface of the porous titania counter electrode was allowed to support the photosensitizing dye. Then, the porous titania counter electrode was rinsed with acetonitrile, followed by evaporating the solvent therefrom in a dark place, and the porous titania counter electrode was dried.

### [Preparation of Dye-Sensitized Solar Cell]

Subsequently, the thus-prepared porous titania counter electrode and the carbon counter electrode were disposed opposite one another, and their outer periphery was sealed with an epoxy-based UV-curable resin which includes a 60 μm spacer.

Next, as an electrolyte, an electrolyte solution, in which Co(II)(bpy)₃-PF₆ (0.2 mol/1), Co(III)(bpy)₃-PF_{6 (}0.05 mol/l), LiTFSI (0.1 mol/l) and t-butylpyridine (0.2 mol/l) are dissolved in acetonitrile, was prepared.

Subsequently, this electrolyte solution was injected with a tubing pump from an inlet of a dye-sensitized solar cell, which has been formed in advance, and air bubbles inside the cell were drove out by reducing the pressure. Then, the inlet was sealed with an epoxy-based UV-curable resin, and thus the dye-sensitized solar cell was completed.

### Comparative Example 12-2

A dye-sensitized solar cell was prepared as in Example 1-1 except that a Pt/Ti counter electrode in which a 100-nm platinum film was formed onto the surface of the Ti plate (1.1t) by sputtering was used.

### II. Evaluation of Dye-Sensitized Solar Cell

### (Evaluation of Initial Characteristics)

The initial characteristics of the thus-prepared dye-sensitized solar cells of Examples and Comparative

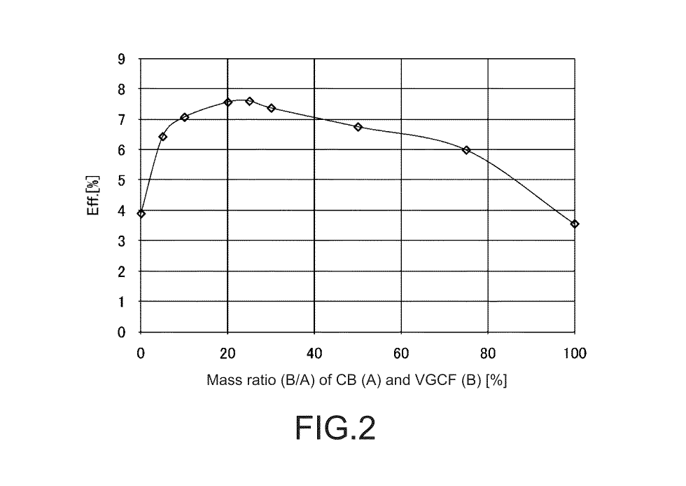

Examples (characteristics immediately after preparation) were evaluated in the following manner. That is, the short-circuit current (Jsc), open-circuit voltage (Voc), fill factor (FF) and photoelectric conversion efficiency (Eff.) thereof in the current-voltage curves under simulated sunlight illumination (AM1.5, 100 mW/cm²) were measured. The measurement results are shown in Tables 1 to 12 and FIGS. 2, 3 and 6.

### (Evaluation of Durability)

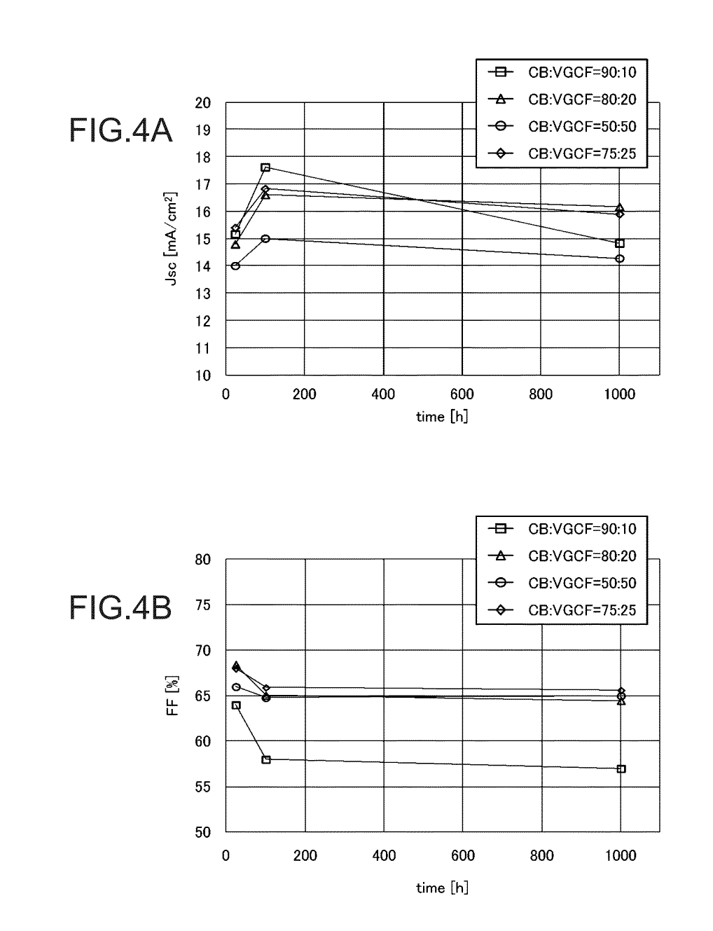

Durability of the thus-prepared dye-sensitized solar cells of Examples and Comparative Examples (characteristics immediately after preparation) was evaluated in the following manner. The dye-sensitized solar cells were kept under dry conditions at a temperature of 85° C. and then the short-circuit current (Jsc), open-circuit voltage (Voc), fill factor (FF) and photoelectric conversion efficiency (Eff.) thereof in the current-voltage curves under simulated sunlight illumination (AM1.5, 100 mW/cm²) were measured. This measurement was repeated several times during the period up to 1000 hours of storage time. The results are shown in FIGS. 4A to 5B and 7A and 18B.

The “fill factor (FF)”, which is also referred to as “form factor”, is one of parameters representing characteristics of a photoelectric conversion device. In the current-voltage curve of an ideal photoelectric conversion device, a fixed output voltage having the same size as the open-circuit voltage is kept until an output current reaches the same size as the short-circuit current. However, the current-voltage curve of an actual photoelectric conversion device becomes in a shape deviated from the ideal current-voltage curve because of the presence of an internal resistance. A ratio of an area of a region surrounded by the actual current-voltage curve, the x-axis and the y-axis with respect to an area of a rectangle surrounded by the ideal current-voltage curve, the x-axis and the y-axis is what is called “fill factor”. The fill factor shows a degree of the deviation from the ideal current-voltage curve and is used in calculating the actual photoelectric conversion efficiency.

### III. Evaluation Results of Dye-Sensitized Solar Cell

### <3-1. Evaluation Results of Type of Material of Carbon Counter Electrode>

### (Evaluation Results of Initial Characteristics)

Table 1 shows the results of evaluation of the initial characteristics of the dye-sensitized solar cells of Example 1-1 and Comparative Examples 1-1 to 1-3.

TABLE 1

| | | | Amount of | Occurrence | | | | |
|---|---|---|---|---|---|---|---|---|
| | Material of counter | Material of counter | addition of PVDF | of cracks in | Jsc | Voc | FF | Eff. |
| | electrode (1) | electrode (2) | [mass %] | electrode | [mA/cm²] | [V] | [%] | [%] |
| Ex. 1-1 | Carbon black | Carbon fiber | 3 | None | 15.4 | 0.725 | 68.0 | 7.59 |
| Comp. Ex. 1-1 | Carbon black | Activated carbon | 3 | Cracks | 12.5 | 0.710 | 55.0 | 4.88 |
| | | YP-80F | | occurred | | | | |
| Comp. Ex. 1-2 | Carbon black | Graphite | 3 | Cracks | 12.6 | 0.712 | 58.0 | 5.20 |
| | | MCMB | | occurred | | | | |
| Comp. Ex. 1-3 | PtTi | — | — | — | 17.3 | 0.712 | 61.0 | 7.52 |

With the carbon counter electrode prepared using the carbon black and the vapor-grown carbon fiber in combination, there were no cracks, and a good counter electrode was obtained. With the dye-sensitized solar cell using such a counter electrode, the photoelectric conversion efficiency obtained was 7.59%. This value of photoelectric conversion efficiency was almost the same as with the dye-sensitized solar cell using the Pt/Ti counter electrode, and was of excellent photoelectric conversion efficiency. On the other hand, with the dye-sensitized solar cells each using the carbon counter electrode prepared using the carbon black and the activated carbon in combination, which has been known from the past, or with the carbon counter electrode prepared using the carbon black and the graphite (MCMB) in combination, the fill factor and the value of photoelectric conversion efficiency were low. It is speculated that the fill factor had become lower because internal cracks and the like were present in the counter electrode in which the carbon black and the activated carbon were combined; or in which the carbon black and the activated carbon were combined.

### <3-2. Evaluation Results of Mass Ratio of Carbon Black and Vapor-Grown Carbon Fiber (Binder: PVDF)>

### (Evaluation Results of Initial Characteristics)

Table 2 shows the results of evaluation of the initial characteristics of the dye-sensitized solar cells of Examples 1-1, 2-1 to 2-6 and Comparative Examples 2-1 and 2-2.

TABLE 2

| | | Amount of | Occurrence | | | | |
|---|---|---|---|---|---|---|---|
| | CB:VGCF | addition of PVDF | of cracks in | Jsc | Voc | FF | Eff. |
| | [mass ratio] | [mass %] | electrode | [mA/cm²] | [V] | [%] | [%] |
| Comp. Ex. 2-1 | 100:0 | 3 | Cracks occurred | 12.0 | 0.720 | 45.0 | 3.89 |
| Ex. 2-1 | 95:5 | 3 | None | 15.1 | 0.721 | 69.0 | 6.42 |
| Ex. 2-2 | 90:10 | 3 | None | 15.2 | 0.726 | 64.0 | 7.06 |
| Ex. 2-3 | 80:20 | 3 | None | 15.2 | 0.731 | 68.0 | 7.56 |
| Ex. 1-1 | 75:25 | 3 | None | 15.4 | 0.725 | 68.0 | 7.59 |
| Ex. 2-4 | 70:30 | 3 | None | 15.2 | 0.723 | 67.0 | 7.36 |
| Ex. 2-5 | 50:50 | 3 | None | 14.0 | 0.730 | 66.0 | 6.75 |
| Ex. 2-6 | 25:75 | 3 | None | 13.1 | 0.725 | 63.0 | 5.98 |
| Comp. Ex. 2-2 | 0:100 | 3 | None | 10.0 | 0.710 | 60.0 | 3.55 |

CB: Carbon black
VGCF: Vapor-grown carbon fiber
PVDF: Polyvinylidene fluoride

When the carbon black alone was used as the carbon material in the carbon electrode, such a carbon electrode was very brittle and fragile. Further, it also resulted in lowering of the fill factor. In cases where the carbon black and the vapor-grown carbon fiber were used in combination, retention force as a counter electrode was able to be kept. When the vapor-grown carbon fiber alone was used as the carbon material in the carbon electrode, although the peel strength became higher, the fill factor and the conversion efficiency were low. It is speculated that the characteristics had become lower because there were fewer active sites of such as carbon black, which active sites are capable of contributing to oxidation-reduction.

FIG. 2 is a graph showing the results of evaluation of conversion efficiency (initial characteristics) of the dye-sensitized solar cells of Examples 1-1, 2-1 to 2-6 and Comparative Examples 2-1 and 2-2. It was revealed that high conversion efficiency can be obtained when the mass ratio (B/A) of the carbon black (A) and the fibrous carbon material (B) is within the range of from 10/90 to 50/50.

### (Evaluation Results of Durability)

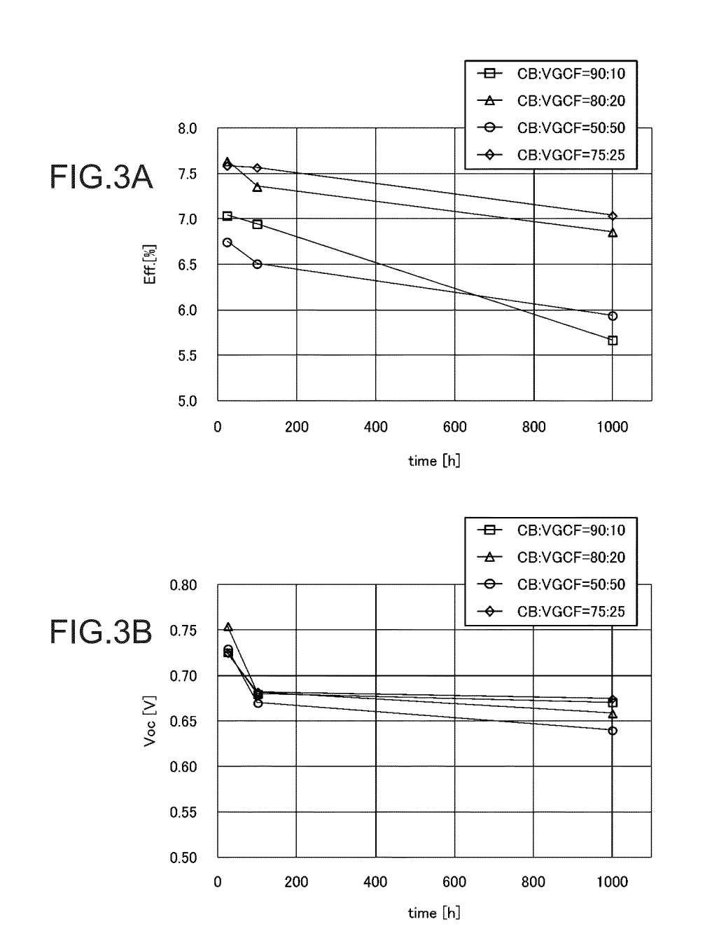

FIGS. 3A to 4B are graphs showing the results of evaluation of durability of the dye-sensitized solar cells of Examples 1-1, 2-2, 2-3 and 2-5. From the durability test, also, it was revealed that the highest characteristics can be obtained when the mass ratio (B/A) of the carbon black (A) and the fibrous carbon material (B) is 25/75.

### <3-3. Evaluation Results of Proportion of PVDF>

### (Evaluation Results of Initial Characteristics)

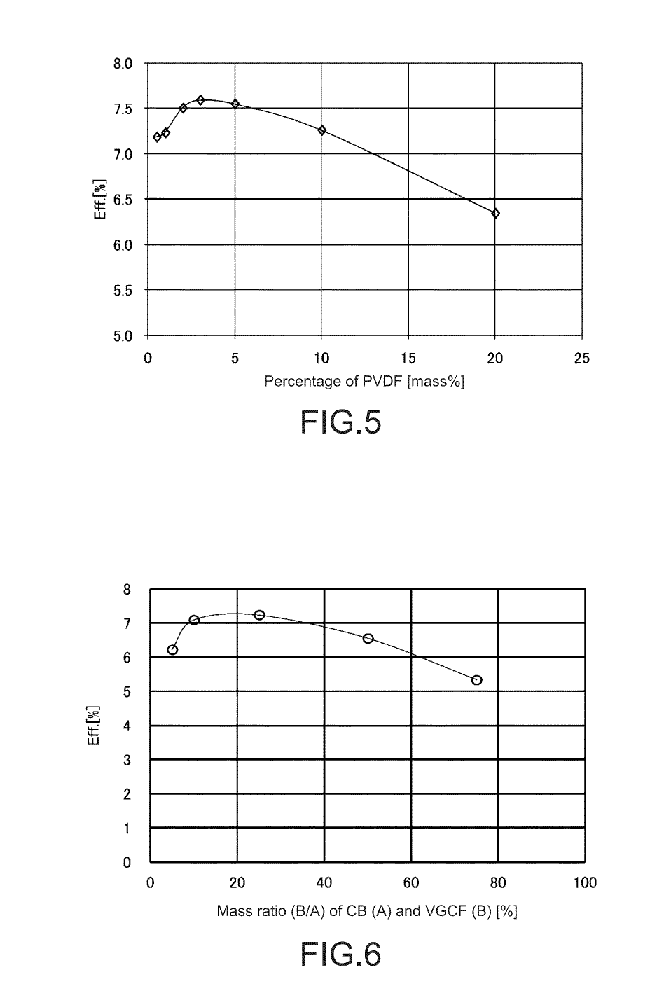

Table 3 shows the results of evaluation of the initial characteristics of the dye-sensitized solar cells of Examples 1-1 and 3-1 to 3-6. FIG. 5 is a graph showing the results of evaluation of conversion efficiency (initial characteristics) of the dye-sensitized solar cells of Examples 1-1 and 3-1 to 3-6.

TABLE 3

| | CB:VGCF | Amount of | | | | |
|---|---|---|---|---|---|---|
| | [mass | addition of PVDF | Jsc | Voc | FF | Eff. |
| | ratio] | [mass %] | [mA/cm²] | [V] | [%] | [%] |
| Ex. 3-1 | 75:25 | 0.5 | 15.1 | 0.732 | 65.0 | 7.19 |
| Ex. 3-2 | 75:25 | 1 | 15.2 | 0.732 | 65.0 | 7.13 |
| Ex. 3-3 | 75:25 | 2 | 15.2 | 0.726 | 68.0 | 7.60 |
| Ex. 1-1 | 75:25 | 3 | 15.4 | 0.725 | 68.0 | 7.69 |
| Ex. 3-4 | 75:25 | 5 | 15.4 | 0.721 | 68.0 | 7.65 |
| Ex. 3-5 | 75:25 | 10 | 15.3 | 0.719 | 66.0 | 7.26 |
| Ex. 3-6 | 75:25 | 20 | 15.0 | 0.705 | 60.0 | 6.35 |

CB: Carbon black
VGCF: Vapor-grown carbon fiber
PVDF: Polyvinylidene fluoride

High conversion efficiency was able to be obtained when the proportion ((N/M)×100) of the polyvinylidene fluoride (N) with respect to the total amount of all the materials that make up the carbon counter electrode (M) was within the range of from 0.5 mass % to 10 mass %. When the proportion ((N/M)×100) was 20 mass %, the conversion efficiency tended to be lower.

### <3-4. Evaluation Results of Mass Ratio of Carbon Black and Vapor-Grown Carbon Fiber (Binder: PAI)>

### (Evaluation Results of Initial Characteristics)

Table 4 shows the results of evaluation of the initial characteristics of the dye-sensitized solar cells of Examples 4-1 to 4-5. FIG. 6 is a graph showing the results of evaluation of conversion efficiency (initial characteristics) of the dye-sensitized solar cells of Examples 4-1 to 4-5.

TABLE 4

| | | Amount of | | | | |
|---|---|---|---|---|---|---|
| | CB:VGCF | addition of PAI | Jsc | Voc | FF | Eff. |
| | [mass ratio] | [mass %] | [mA/cm²] | [V] | [%] | [%] |
| Ex. 4-1 | 95:5 | 2 | 13.8 | 0.715 | 63.0 | 6.22 |
| Ex. 4-2 | 90:10 | 2 | 14.8 | 0.715 | 67.0 | 7.09 |
| Ex. 4-3 | 75:25 | 2 | 14.9 | 0.714 | 68.0 | 7.23 |
| Ex. 4-4 | 50:50 | 2 | 14.5 | 0.706 | 64.0 | 6.55 |
| Ex. 4-5 | 25:75 | 2 | 14.5 | 0.694 | 53.0 | 5.33 |

CB: Carbon black
VGCF: Vapor-grown carbon fiber
PAI: Polyamide-imide

From these results of evaluation of the initial characteristics, also, it was revealed that high conversion efficiency can be obtained when the mass ratio (B/A) of the carbon black (A) and the fibrous carbon material (B) is within the range of from 10/90 to 50/50.

### (Evaluation Results of Durability)

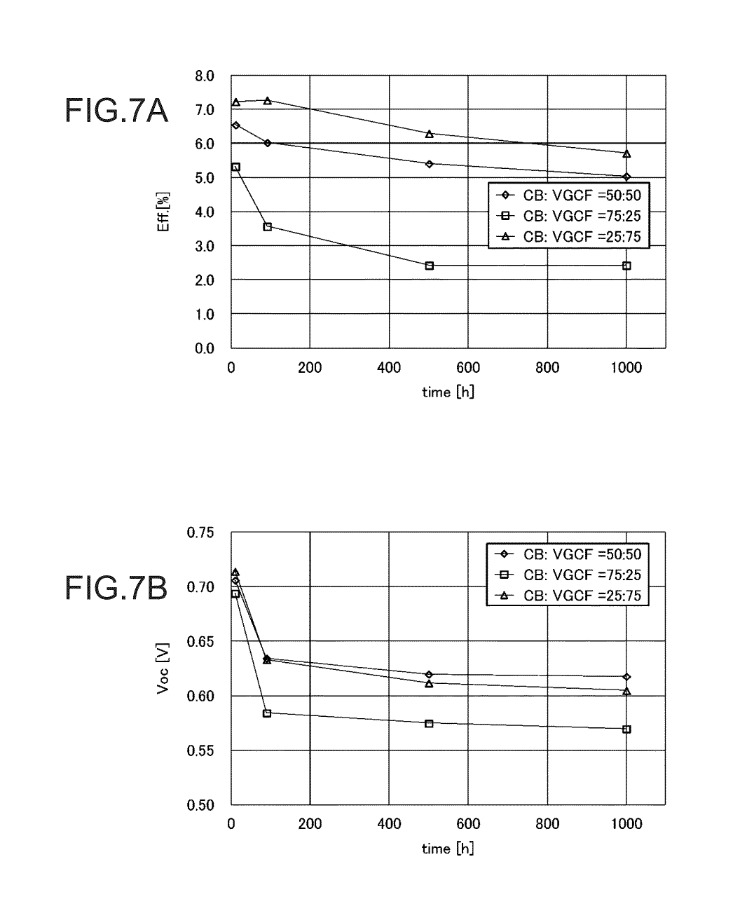

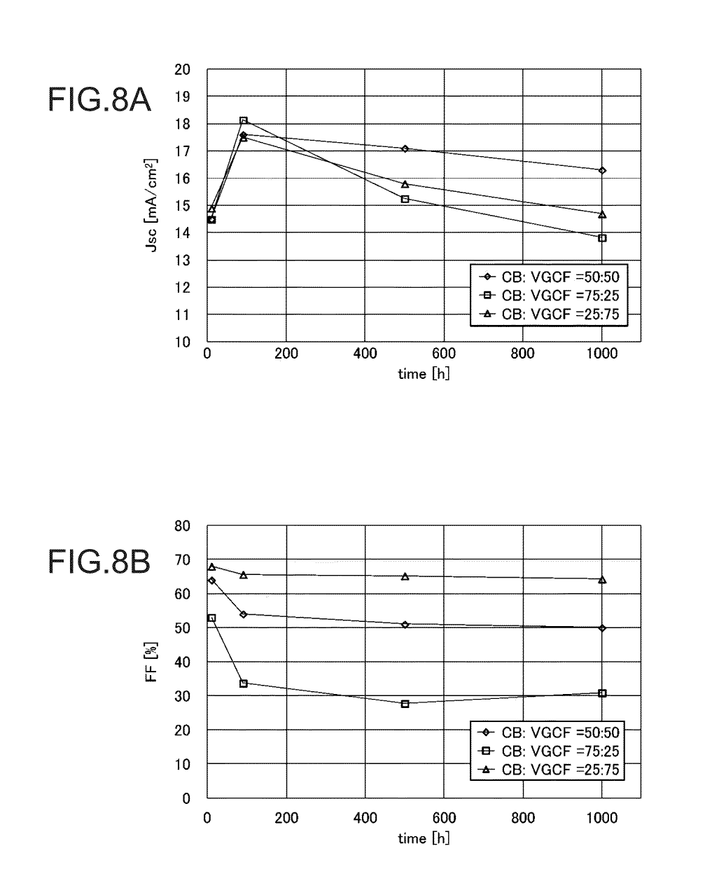

FIGS. 7A to 8B are graphs showing the results of evaluation of durability of the dye-sensitized solar cells of Examples 4-3 to 4-5. From these results of evaluation of durability, as well, it was revealed that the highest durability can be obtained when the mass ratio (B/A) of the carbon black (A) and the fibrous carbon material (B) is 25/75.

### <3-5. Evaluation Results of Thickness of Carbon Counter Electrode>

Table 5 shows the results of evaluation of the initial characteristics of the dye-sensitized solar cells of Examples 1-1 and 5-1 to 5-4.

TABLE 5

| | CB:VGCF | Thickness | Jsc | Voc | FF | Eff. |
|---|---|---|---|---|---|---|
| | [mass ratio] | [μm] | [mA/cm²] | [V] | [%] | [%] |
| Ex. 5-1 | 75:25 | 15 | 15.0 | 0.725 | 65.0 | 7.07 |
| Ex. 5-2 | 75:25 | 25 | 15.1 | 0.726 | 67.0 | 7.34 |
| Ex. 1-1 | 75:25 | 35 | 15.4 | 0.725 | 68.0 | 7.59 |
| Ex. 5-3 | 75:25 | 45 | 15.7 | 0.721 | 67.0 | 7.58 |
| Ex. 5-4 | 75:25 | 55 | 15.7 | 0.720 | 65.0 | 7.35 |

CB: Carbon black
VGCF: Vapor-grown carbon fiber
PVDF: Polyvinylidene fluoride

These evaluation results revealed that the thickness of the carbon counter electrode is desirable to be within the range of from 25 μm to 45 μm.

### <3-6. Evaluation Results of Specific Surface Area of Carbon Black>

Table 6 shows the results of evaluation of the initial characteristics of the dye-sensitized solar cells of Examples 1-1 and 6-1 to 6-4.

TABLE 6

| | | | Amount of | | | | |
|---|---|---|---|---|---|---|---|
| | BET specific surface area | CB:VGCF | addition of PVDF | Jsc | Voc | FF | Eff. |
| | [m²/g] | [mass ratio] | [mass %] | [mA/cm²] | [V] | [%] | [%] |
| Ex. 6-1 | 150 | 75:25 | 3 | 13.9 | 0.731 | 63.0 | 6.40 |
| Ex. 6-2 | 250 (#900) | 75:25 | 3 | 14.6 | 0.724 | 65.0 | 6.87 |
| Ex. 6-3 | 300 (#2300) | 75:25 | 3 | 15.1 | 0.726 | 68.0 | 7.45 |
| Ex. 1-1 | 370 (#2500) | 75:25 | 3 | 15.4 | 0.725 | 68.0 | 7.59 |
| Ex. 6-4 | 800 (# Ketien Black) | 75:25 | 3 | 13.2 | 0.720 | 43.0 | 4.09 |

CB: Carbon black
VGCF: Vapor-grown carbon fiber
PVDF: Polyvinylidene fluoride

There was a tendency that high conversion efficiency can be obtained at a BET specific surface area of 300 m²/g or more. However, when Ketjen Black having a BET specific surface area of 800 m²/g was used, only low conversion efficiency was obtained. It is speculated that this is because, for having high oil absorption, the carbon absorbed the solvent excessively and resulted in gelling of the carbon slurry.

### <3-7. Evaluation Results of Amount of Addition of ITO Particles>

### (Evaluation Results of Initial Characteristics)

Table 7 shows the results of evaluation of the initial characteristics of the dye-sensitized solar cells of Examples 7-1 to 7-3.

TABLE 7

| | | | Conductive powder | | | | | | |
|---|---|---|---|---|---|---|---|---|---|
| | | | | Average | | | | | |
| | | Amount of | | particle | Amount of | | | | |
| | CB:VGCF | addition of PVDF | | diameter | addition | Jsc | Voc | FF | Eff. |
| | [mass ratio] | [mass %] | Material | [nm] | [mass %] | [mA/cm²] | [V] | [%] | [%] |
| Ex. 6-3 | 75:25 | 3 | — | — | — | 15.1 | 0.726 | 68.0 | 7.45 |
| Ex. 7-1 | 75:25 | 3 | ITO | 30 nm | 8 | 15.5 | 0.738 | 68.0 | 7.78 |
| Ex. 7-2 | 75:25 | 3 | ITO | 30 nm | 16 | 15.6 | 0.740 | 69.0 | 7.97 |
| Ex. 7-3 | 75:25 | 3 | ITO | 30 nm | 35 | 15.0 | 0.738 | 60.0 | 5.64 |

CB: Carbon black
VGCF: Vapor-grown carbon fiber
PVDF: Polyvinylidene fluoride

When the proportion ((L/M)×100) of the ITO particles (L) with respect to the total amount of all the materials that make up the carbon counter electrode (M) was 8 mass % or more and 16 mass % or less, the conversion efficiency was improved. When the proportion ((L/M)×100) of the ITO particles (L) with respect to the total amount of all the materials that make up the carbon counter electrode (M) was 35 mass %, the conversion efficiency was lowered.

### (Evaluation Results of Durability)

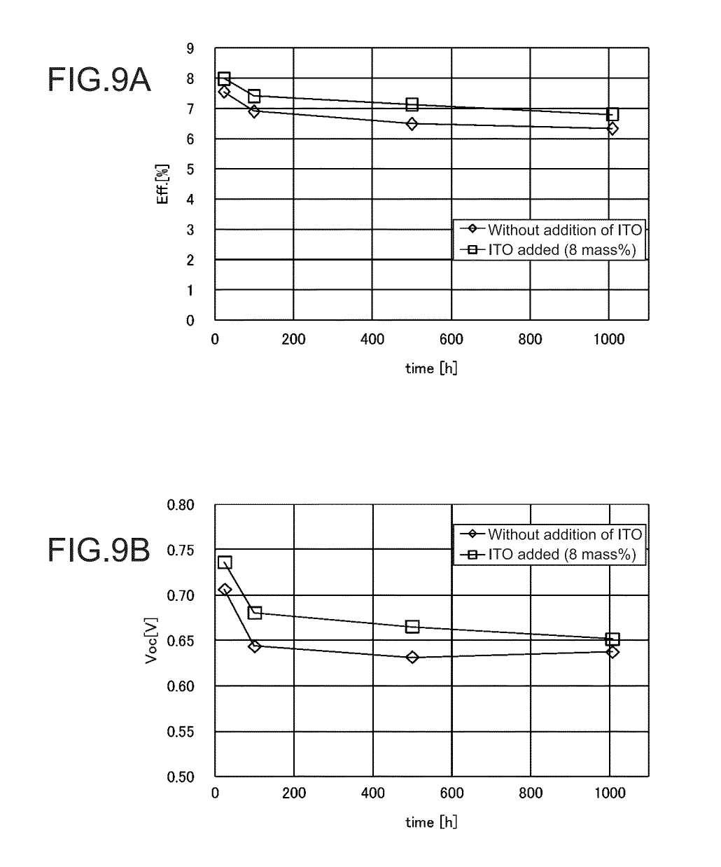

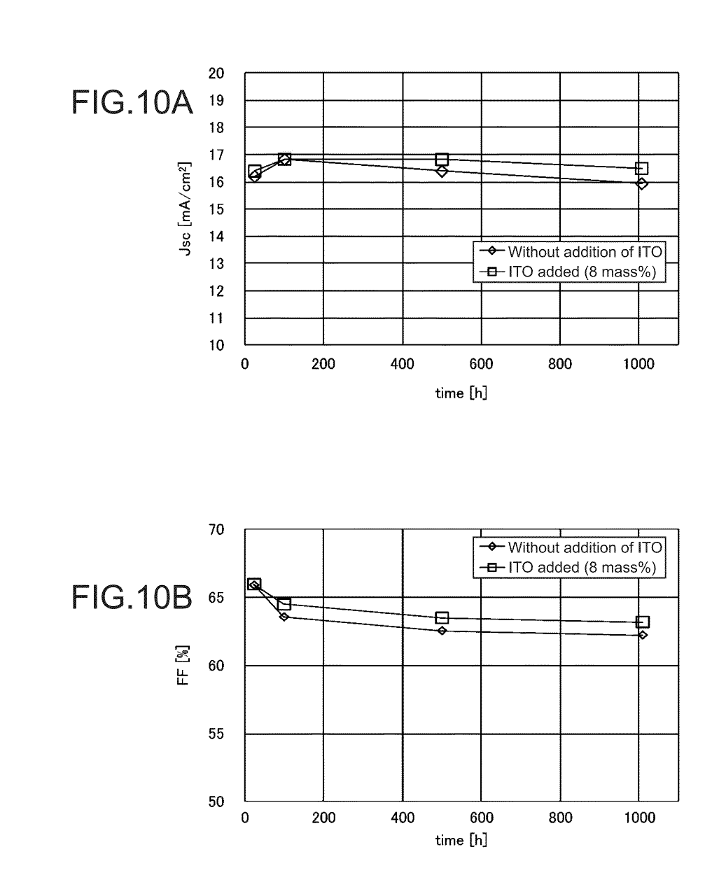

FIGS. 9A to 10B are graphs showing the results of evaluation of durability of the dye-sensitized solar cells of Examples 6-3 and 7-1 to 7-3. It was revealed that in the case where ITO particles are added to the carbon counter electrode, excellent cell characteristics can be maintained for a long time as compared with the case where ITO particles are not added to the carbon counter electrode.

### <3-8. Evaluation Results of Amount of Addition of Hydrotalcite>

### (Evaluation Results of Initial Characteristics)

Table 8 shows the results of evaluation of the initial characteristics of the dye-sensitized solar cells of Examples 8-1 to 8-5.

TABLE 8

| | | Amount of addition | | Amount of | | | | |
|---|---|---|---|---|---|---|---|---|
| | CB:VGCF | of PVDF | | addition | Jsc | Voc | FF | Eff. |
| | [mass ratio] | [mass %] | Hydrotalcite | [mass %] | [mA/cm²] | [V] | [%] | [%] |
| Ex. 3-3 | 75:25 | 2 | — | 0 | 15.2 | 0.726 | 68.0 | 7.50 |
| Ex. 8-1 | 75:25 | 2 | MgAl⁺, CO₃²⁻ | 0.1 | 15.0 | 0.743 | 68.0 | 7.58 |
| Ex. 8-2 | 75:25 | 2 | MgAl⁺, CO₃²⁻ | 1 | 14.6 | 0.757 | 69.0 | 7.63 |
| Ex. 8-3 | 75:25 | 2 | MgAl⁺, CO₃²⁻ | 3 | 14.2 | 0.774 | 71.0 | 7.80 |
| Ex. 8-4 | 75:25 | 2 | MgAl⁺, CO₃²⁻ | 5 | 13.8 | 0.778 | 72.0 | 7.73 |
| Ex. 8-5 | 75:25 | 2 | MgAl⁺, CO₃²⁻ | 10 | 13.0 | 0.784 | 74.0 | 7.54 |

CB: Carbon black
VGCF: Vapor-grown carbon fiber
PVDF: Polyvinylidene fluoride

It was revealed that the addition of even a small amount of hydrotalcite enhances the cell characteristics, particularly, the open-circuit voltage (Voc). It was revealed that the conversion efficiency improves by making the proportion ((K/M)×100) of the hydrotalcite (K) with respect to the total amount of all the materials that make up the carbon counter electrode (M) within the range of from 0.1 mass % to 10 mass %.

### (Evaluation Results of Durability)

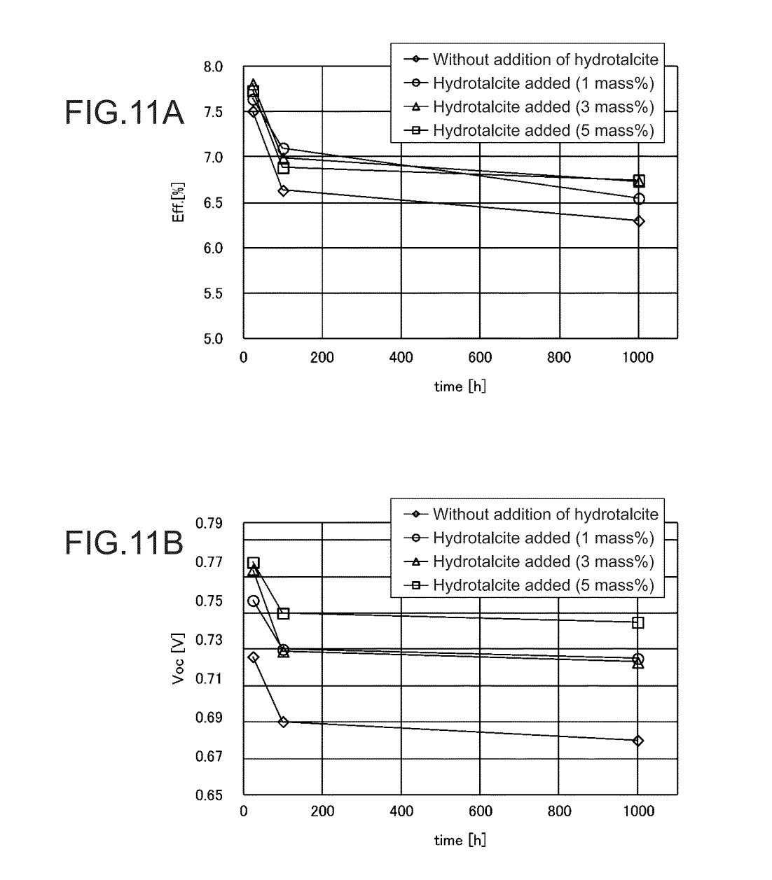

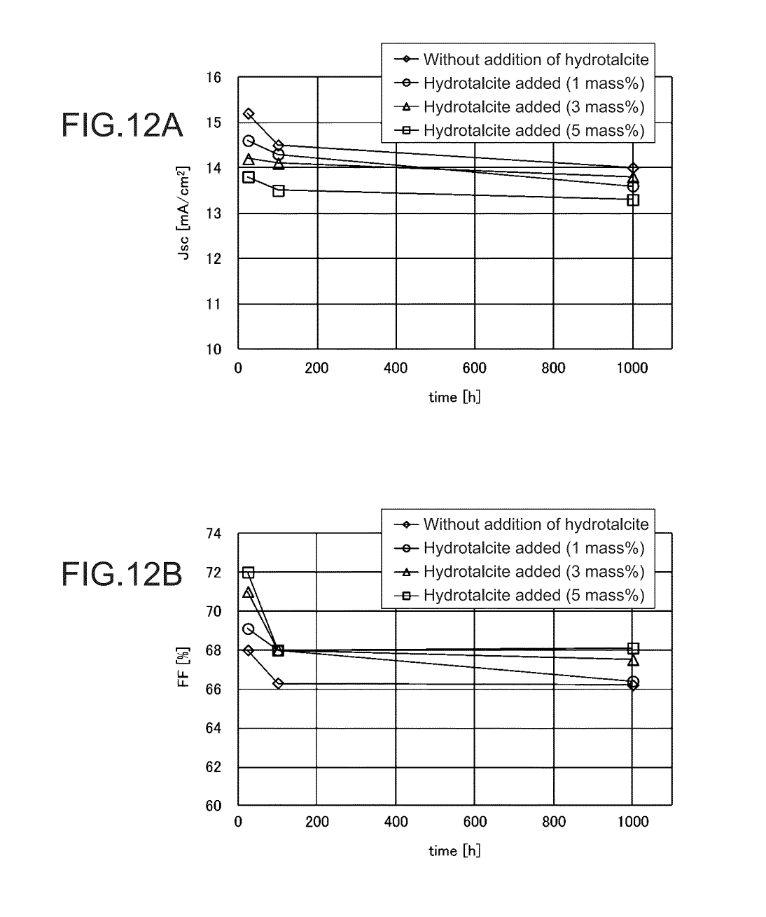

FIGS. 11A to 12B are graphs showing the results of evaluation of durability of the dye-sensitized solar cells of Examples 3-3 and 8-2 to 8-4. It was revealed that in the case where hydrotalcite is added to the carbon counter electrode, excellent cell characteristics can be maintained for a long time as compared with the case where hydrotalcite is not added to the carbon counter electrode.

### (Evaluation Results of Initial Characteristics)

Table 9 shows the results of evaluation of the initial characteristics of the dye-sensitized solar cells of Examples 8-4 and 8-6.

TABLE 9

| | | Amount of addition of | | Amount of | | | | |
|---|---|---|---|---|---|---|---|---|
| | CB:VGCF | PVDF | | addition | Jsc | Voc | FF | Eff. |
| | [mass ratio] | [mass %] | Hydrotalcite | [mass %] | [mA/cm²] | [V] | [%] | [%] |
| Ex. 8-4 | 75:25 | 2 | MgAl⁺, CO₃²⁻ | 5 | 13.8 | 0.778 | 72.0 | 7.73 |
| Ex. 8-6 | 75:25 | 2 | MgAl⁺, NO₃⁻ | 5 | 13.9 | 0.775 | 72.0 | 7.76 |

CB: Carbon black
VGCF: Vapor-grown carbon fiber
PVDF: Polyvinylidene fluoride

There was not much difference between nitrate ion and carbonate ion seen in the cell characteristics.

### <3-9. Evaluation Results of Addition of Hydrophobic Silica Particles>

### (Evaluation Results of Initial Characteristics)

Table 10 shows the results of evaluation of the initial characteristics of the dye-sensitized solar cells of Examples 1-1 and 9-1 to 9-6.

TABLE 10

| | | | Surface-modified silica | | | | | | | |
|---|---|---|---|---|---|---|---|---|---|---|
| | | | | Average | | | | | | |
| | CB:VGCF | Amount of addition | | particle | | Amount of | | | | |
| | [mass | of PVDF | | diameter | Hydrophobic | addition | Jsc | Voc | FF | Eff. |
| | ratio] | [mass %] | Material | [μm] | treatment | [mass %] | [mA/cm²] | [V] | [%] | [%] |
| Ex. 1-1 | 76:25 | 3 | | | | | 15.4 | 0.725 | 68.0 | 7.59 |
| Ex. 9-1 | 76:25 | 3 | Aerosil: | 12 | Octylsilane | 3 | 15.3 | 0.745 | 68.0 | 7.75 |
| | | | R805 | | treatment | | | | | |
| Ex. 9-2 | 76:25 | 3 | Aerosil: | 12 | Octylsilane | 5 | 15.6 | 0.745 | 68.7 | 7.98 |
| | | | R805 | | treatment | | | | | |
| Ex. 9-3 | 76:25 | 3 | Aerosil: | 14 | Dimethyl | 5 | 15.6 | 0.745 | 68.0 | 7.90 |
| | | | R202 | | silicone oil | | | | | |
| Ex. 9-4 | 76:25 | 3 | Aerosil: | 12 | Trimethylsilyl | 5 | 15.8 | 0.740 | 68.0 | 7.95 |
| | | | RX300 | | group | | | | | |
| Ex. 9-5 | 75:25 | 3 | Aerosil: | 12 | Methyl group | 5 | 15.6 | 0.732 | 68.0 | 7.77 |
| | | | R974 | | | | | | | |
| Ex. 9-6 | 75:25 | 3 | Aerosil | 12 | Without | 5 | 15.0 | 0.694 | 67.0 | 5.92 |
| | | | 200 | | surface | | | | | |
| | | | | | treatment | | | | | |

CB: Carbon black
VGCF: Vapor-grown carbon fiber
PVDF: Polyvinylidene fluoride

When the hydrophilic silica particles (Aerosil 200) that have not undergone a hydrophobic treatment were added to the carbon counter electrode, the conversion efficiency was 5.92%, and was revealed to be decreased as compared with that of the case where no silica particles were added to the carbon counter electrode, which was 7.50%. On the other hand, it was revealed that in cases where the hydrophobic silica particles that have undergone the hydrophobic treatment of various types were added to the carbon counter electrode, the conversion efficiency would improve by any of these hydrophobic silica particles.

### (Evaluation Results of Durability)

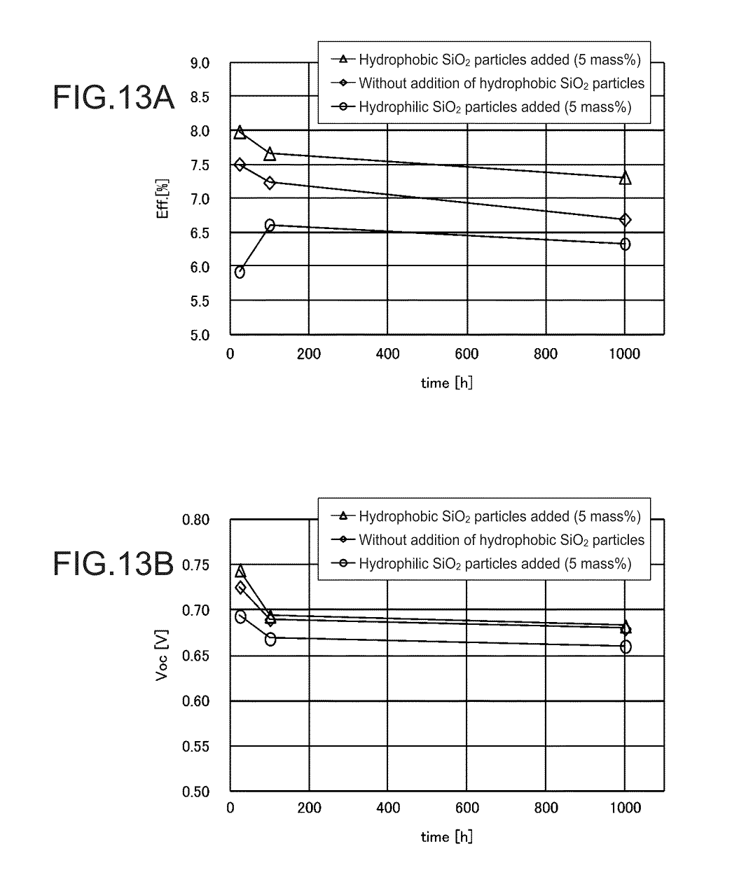

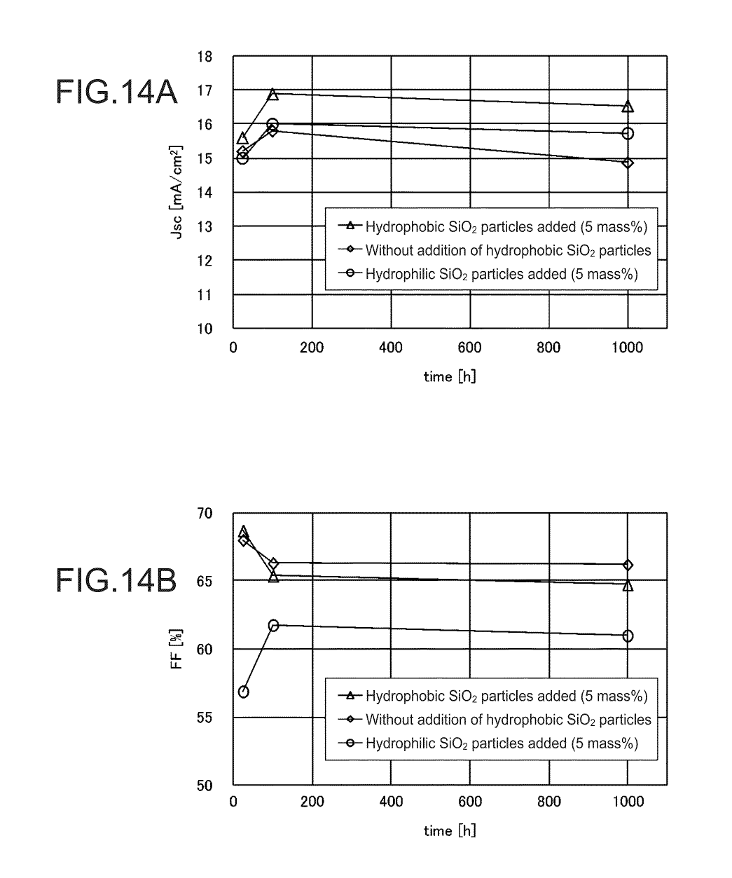

FIGS. 13A to 14B are graphs showing the results of evaluation of durability of the dye-sensitized solar cells of Examples 1-1, 9-2 and 9-6. It was revealed that in the case where the carbon counter electrode with an addition of hydrophobic silica particles is used, excellent cell characteristics can be maintained for a long time as compared with the case where the carbon counter electrode without addition of hydrophobic silica particles is used. On the other hand, it was revealed that the cell characteristics would be low for a long time in the case where hydrophilic silica particles that have not undergone a hydrophobic treatment are used. That is, from the viewpoint of improvement in durability, it was revealed to be desirable to employ hydrophilic silica particles that have undergone a hydrophobic treatment (surface treatment).

### <3-10. Evaluation Results of Amount of Addition of CNT>

### (Evaluation Results of Initial Characteristics)

Table 11 shows the results of evaluation of the initial characteristics of the dye-sensitized solar cells of Examples 1-1, 10-1 to 10-3 and Comparative Example 10-1

TABLE 11

| | | | | Amount of | | | | |
|---|---|---|---|---|---|---|---|---|
| | | | CB:Carbon fiber | addition of PVDF | Voc | Jsc | FF | Eff. |
| | CB | Carbon fiber | [mass ratio] | [mass %] | [V] | [mA/cm²] | [%] | [%] |
| Ex. 1-1 | #2600 | VGCF | 75:25 | 3 | 0.725 | 15.4 | 68.0 | 7.59 |
| Comp. Ex. 10-1 | #2600 | — | 100:0 | 3 | 0.739 | 15.4 | 52.6 | 5.99 |
| Ex. 10-1 | #2600 | MWCNT | 99:1 | 3 | 0.737 | 15.1 | 50.9 | 5.78 |
| Ex. 10-2 | #2600 | MWCNT | 97:3 | 3 | 0.744 | 15.1 | 65.8 | 7.41 |
| Ex. 10-3 | #2600 | MWCNT | 90:10 | 3 | 0.741 | 15.3 | 66.2 | 7.48 |

CB: Carbon black
VGCF: Vapor-grown carbon fiber
MWCNT: Multi-walled carbon nanotubes

It was revealed that the initial characteristics of the dye-sensitized solar cell tend to improve also in the case where multi-walled carbon nanotubes (MWCNT) are employed as the fibrous carbon material, as when the vapor-grown carbon fiber (VGCF) was employed as the fibrous carbon material.

### (Evaluation Results of Durability)

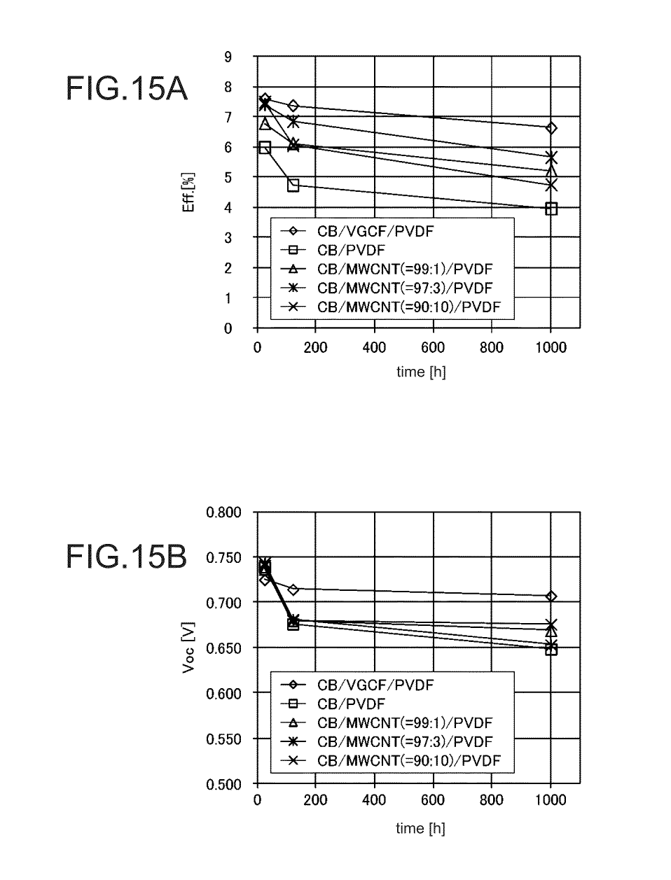

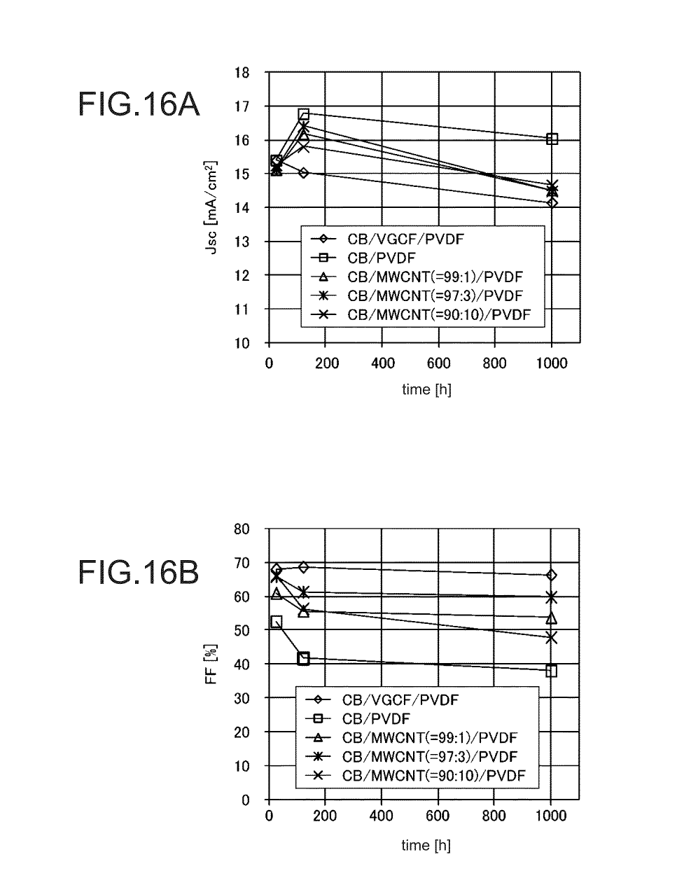

FIGS. 15A to 16B are graphs showing the results of evaluation of durability of the dye-sensitized solar cells of Examples 1-1, 10-1 to 10-3 and Comparative Example 10-1. It was revealed that in the case where multi-walled carbon nanotubes (MWCNT) are employed as the fibrous carbon material, durability of the dye-sensitized solar cell would be lower than that of the case where a vapor-grown carbon fiber (VGCF) is employed as the fibrous carbon material. Therefore, from the viewpoint of improving both the initial characteristics and durability, it is desirable to employ a vapor-grown carbon fiber (VGCF) as the fibrous carbon material.

### <3-11. Evaluation Results of Surface pH of Carbon Black>

### (Evaluation Results of Initial Characteristics)

Table 12 shows the results of evaluation of the initial characteristics of the dye-sensitized solar cells of Examples 11-1 to 11-4.

TABLE 12

| | | BET specific surface | | | Amount of | | | | |
|---|---|---|---|---|---|---|---|---|---|
| | | area of CB | Surface pH | CB:VGCF | addition of PVDF | Voc | Jsc | FF | Eff. |
| | CB | [m²/g] | of CB | [mass ratio] | [mass %] | [V] | [mA/cm²] | [%] | [%] |
| Ex. 11-1 | #2300 | 300 | 8 | 77:23 | 3 | 0.709 | 16.4 | 68.6 | 7.99 |
| Ex. 11-2 | #2350 | 300 | 2.5 | 77:23 | 3 | 0.653 | 16.5 | 65.0 | 7.01 |
| Ex. 11-3 | #2600 | 370 | 6.5 | 77:23 | 3 | 0.712 | 16.4 | 69.0 | 8.22 |
| Ex. 11-4 | #2650 | 370 | 3 | 77:23 | 3 | 0.656 | 16.4 | 65.6 | 7.06 |

CB: Carbon black
VGCF: Vapor-grown carbon fiber

A pH value of the surface of the carbon black indicates the acidity of the carbon surface, and is speculated to be due to that there are a large number of carboxyl groups such as —COOH and/or hydroxyl groups such as —OH. When the surface pH is low, the open-circuit voltage (Voc) is low, and the fill factor (FF) also tends to be low. Thus, the surface pH value is desirable to be in the neutral range.

### (Evaluation Results of Durability)

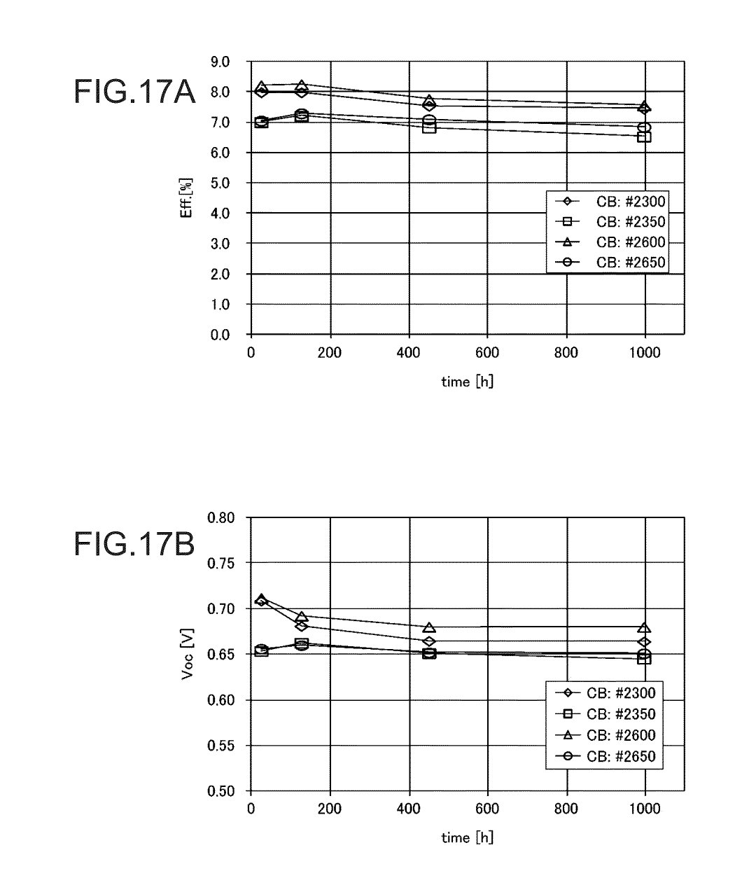

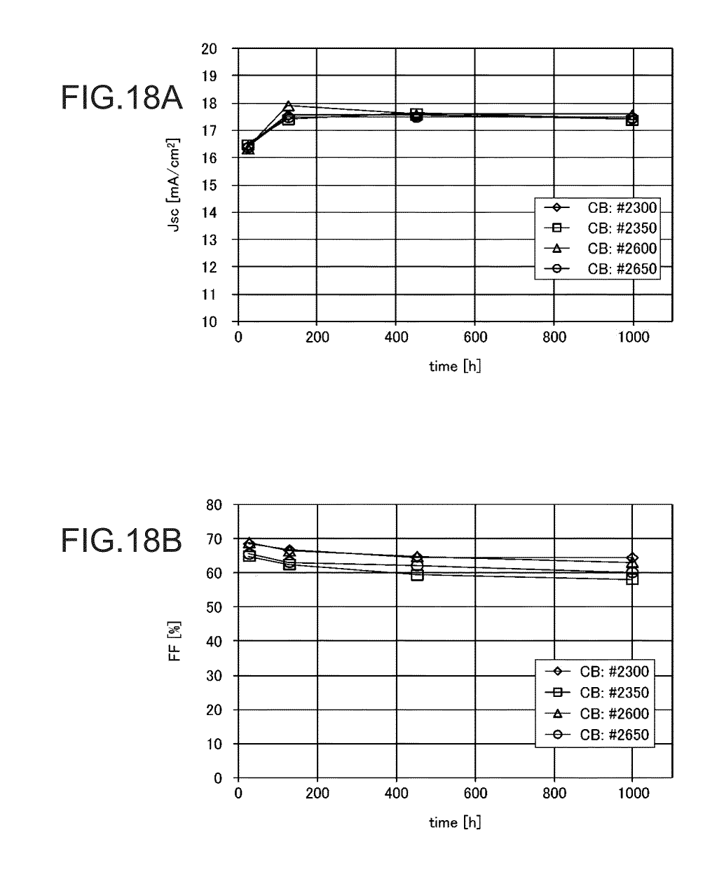

FIGS. 17A to 18B are graphs showing the results of evaluation of durability of the dye-sensitized solar cells of Examples 11-1 to 11-4. In the storage test at 85° C., the durability was changing while maintaining the order, and showed no difference in rate of deterioration among these Examples.

### (Results of SEM Observation)

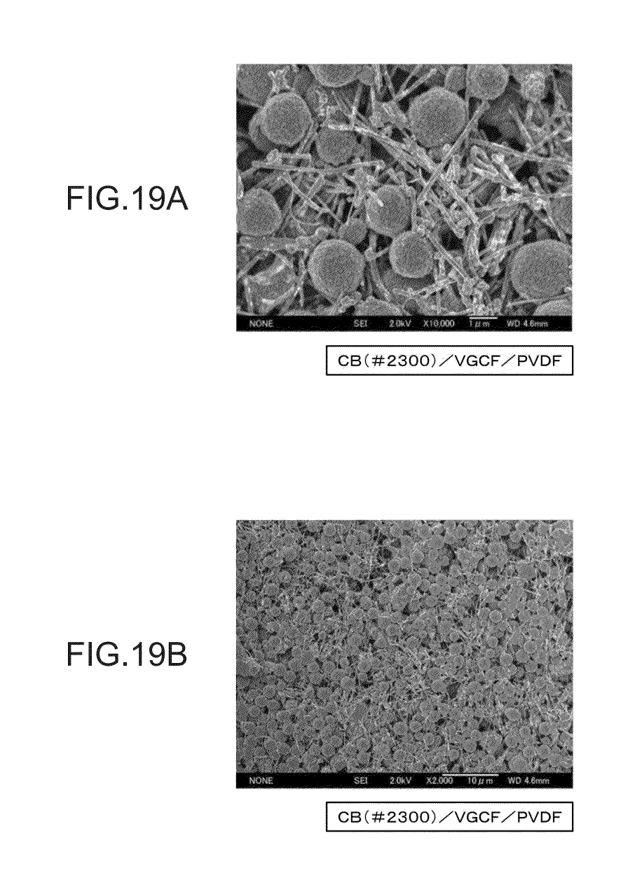

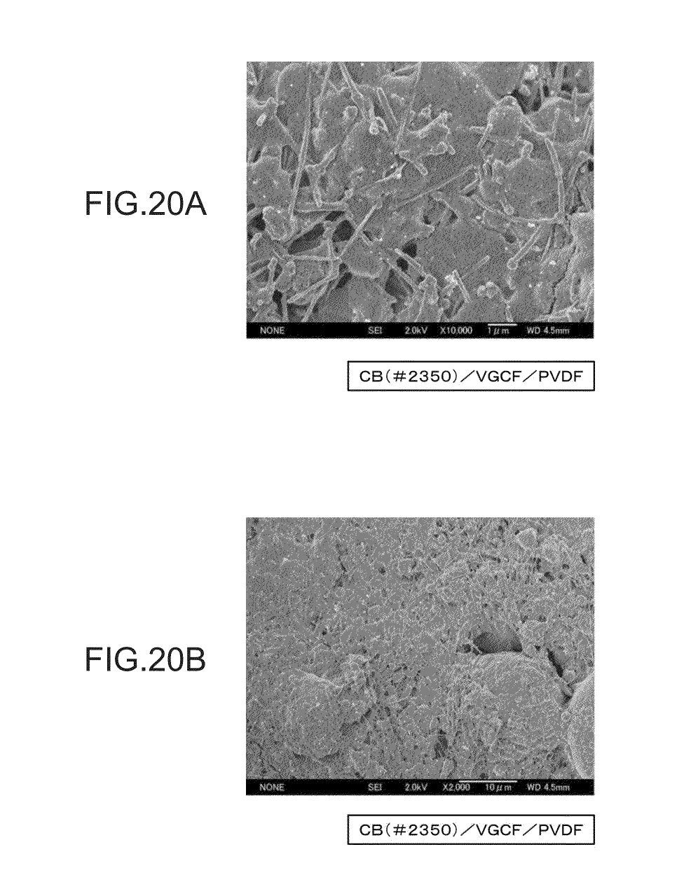

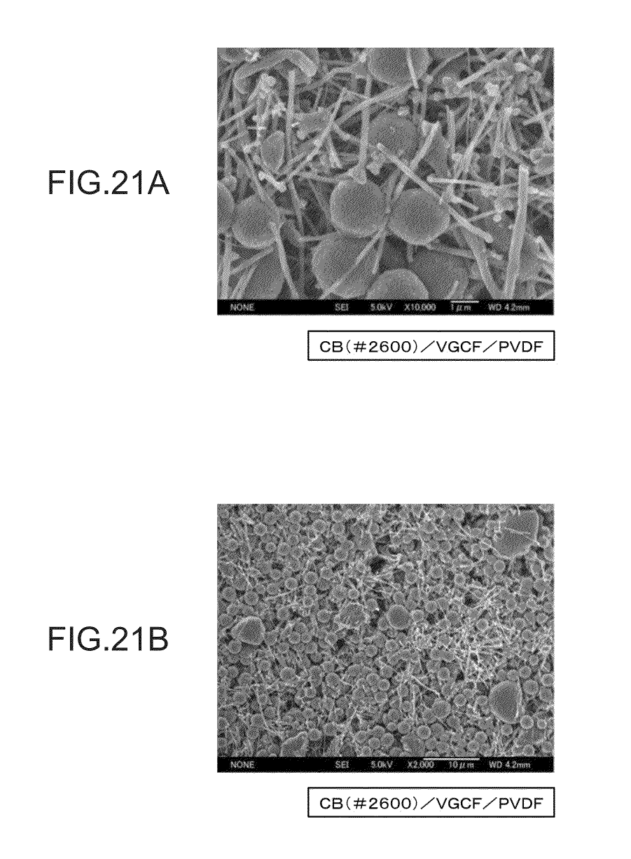

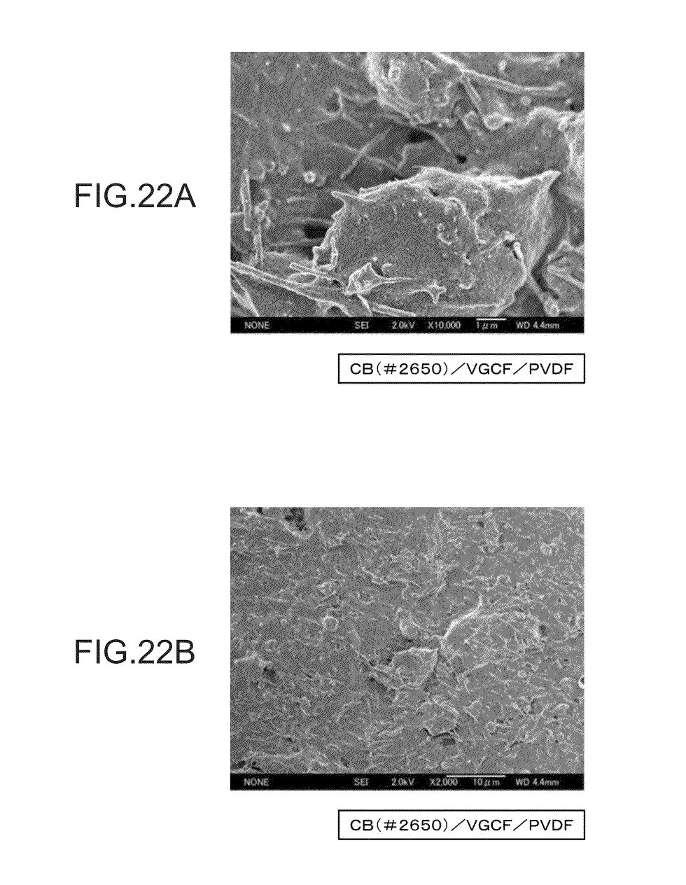

FIGS. 19A to 22B show some results of SEM (scanning electron microscopy) observation of the carbon counter electrodes of Example 11-1 to 11-4. It was revealed that with the carbon black having a pH in the neutral range (#2300, #2600), a mixture of spherically-aggregated carbon black (CB) and vapor-grown carbon fiber (VGCF) is formed. On the other hand, with the carbon black having an acid pH (#2350, #2650), it was revealed that a uniformly mixed film is formed.

<3-12. Evaluation Results for Cell in which Electrolyte Solution Using Co Complex Mediator is Employed>

### (Evaluation Results of Initial Characteristics)

Table 13 Shows The Results Of Evaluation Of The initial characteristics of the dye-sensitized solar cells of Example 12-1 and Comparative Example 12-2.

TABLE 13

| | | | Amount of | | | | |
|---|---|---|---|---|---|---|---|
| | Material counter | Material of counter | addition of PVDF | Jsc | Voc | FF | Eff. |
| | electrode (1) | electrode (2) | [mass %] | [mA/cm²] | [V] | [%] | [%] |
| Ex. 12-1 | Carbon black | Carbon fiber | 3 | 15.2 | 0.762 | 72.0 | 8.35 |
| Comp. Ex. 12-2 | Pt/Ti | — | — | 14.9 | 0.752 | 66.0 | 7.39 |

It was revealed that when the electrolyte solution using Co complex mediator is used, all of the short-circuit current (Jsc), open-circuit voltage (Voc) and fill factor (FF) tend to be higher than those of the case where Pt is used, and thus shows high conversion efficiency.

Hereinbefore, although the specific embodiments of the present disclosure have been described, the present disclosure is not limited to the aforementioned embodiments, and various modifications are available based on the technical idea of the present invention.

For example, the configurations, the methods, the processes, the shapes, the materials, the numerical values and the like which have been described in the aforementioned embodiments are only an example, and configurations, methods, processes, shapes, materials, numerical values and the like different therefrom may be used as necessary.

Further, the configurations, the methods, the processes, the shapes, the materials, the numerical values, and the like which have been described in the aforementioned embodiments may be combined with each other without parting from the gist of the present disclosure.

In addition, a plurality of dye-sensitized solar cells of the aforementioned embodiments may be combined to form a module. Such a plurality of dye-sensitized solar cells may be electrically connected in series and/or in parallel, and in cases where the cells were combined and provided in series, for example, high electromotive voltage can be obtained.

The present disclosure can take the following configurations.

(1) An electrode, including:

carbon black;

a fibrous carbon material; and

an organic binder;

the carbon black (A) and the fibrous carbon material (B) being in a mass ratio (B/A) within the range of from 10/90 to 50/50.

(2) The electrode according to (1), in which

the fibrous carbon material is forming an electrical path among the carbon black.

(3) The electrode according to (1) or (2), in which

the carbon black has a surface pH of from 6 to 9.

(4) The electrode according to any one of (1) to (3), further including:

a conductive powder having a powder resistivity of equal to or less than 10 mΩ.

(5) The electrode according to (4), in which

the conductive powder contains at least one selected from the group consisting of ITO particulates, ZnO particulates and titanium hydride particles.

(6) The electrode according to any one of (1) to (5), further including:

hydrotalcite particles.

(7) The electrode according to (6), in which

the hydrotalcite particles contain magnesium as the main component.

(8) The electrode according to any one of (1) to (7), further including:

hydrophobic silica particles.

(9) The electrode according to any one of (1) to (8), in which

the proportion of the organic binder is within the range of from 0.5 mass % to 5.0 mass %.

(10) The electrode according to any one of (1) to (9), in which

the organic binder contains at least one selected from the group consisting of polyvinylidene fluoride, polytetrafluoroethylene, polyamide-imide, aramid, polyacrylonitrile and polymethacrylonitrile.

(11) A photoelectric conversion element, including:

a photoelectrode;

an electrolyte layer; and

a counter electrode which is the electrode according to any one of (1) to (10).

(12) An electronic apparatus, including:

at least one photoelectric conversion element which is the photoelectric conversion element according to (11).

(13) An architectural structure, including:

at least one photoelectric conversion element which is the photoelectric conversion element according to (11).

(14) The architectural structure according to (13), further including:

two transparent plates;

at least one out of the at least one photoelectric conversion element and/or a module of photoelectric conversion elements being sandwiched between the two transparent plates.

The present disclosure contains subject matter related to that disclosed in Japanese Priority Patent Application JP 2012-126733 filed in the Japan Patent Office on Jun. 4, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electrode, comprising:
carbon black;
a fibrous carbon material; and
an organic binder;
the carbon black (A) and the fibrous carbon material (B) being in a mass ratio (B/A) within the range of from 10/90 to 50/50.

2. The electrode according to claim 1, wherein
the fibrous carbon material is forming an electrical path among the carbon black.

3. The electrode according to claim 1, wherein
the carbon black has a surface pH of from 6 to 9.

4. The electrode according to claim 1, further comprising:
a conductive powder having a powder resistivity of equal to or less than 10 mΩ.

5. The electrode according to claim 4, wherein
the conductive powder contains at least one selected from the group consisting of ITO particulates, ZnO particulates and titanium hydride particles.

6. The electrode according to claim 1, further comprising:
hydrotalcite particles.

7. The electrode according to claim 6, wherein
the hydrotalcite particles contain magnesium as the main component.

8. The electrode according to claim 1, further comprising:
hydrophobic silica particles.

9. The electrode according to claim 1, wherein
the proportion of the organic binder is within the range of from 0.5 mass % to 5.0 mass %.

10. The electrode according to claim 1, wherein
the organic binder contains at least one selected from the group consisting of polyvinylidene fluoride, polytetrafluoroethylene, polyamide-imide, aramid, polyacrylonitrile and polymethacrylonitrile.

11. A photoelectric conversion element, comprising:
a photoelectrode;
an electrolyte layer; and
a counter electrode including
carbon black,
a fibrous carbon material, and
an organic binder,
the carbon black (A) and the fibrous carbon material (B) being in a mass ratio (B/A) within the range of from 10/90 to 50/50.

12. An electronic apparatus, comprising:
at least one photoelectric conversion element having
a photoelectrode,
an electrolyte layer, and
a counter electrode including
carbon black,
a fibrous carbon material, and
an organic binder,
the carbon black (A) and the fibrous carbon material (B) being in a mass ratio (B/A) within the range of from 10/90 to 50/50.

13. An architectural structure, comprising:
at least one photoelectric conversion element having
a photoelectrode,
an electrolyte layer, and
a counter electrode including
carbon black,
a fibrous carbon material, and
an organic binder,
the carbon black (A) and the fibrous carbon material (B) being in a mass ratio (B/A) within the range of from 10/90 to 50/50.

14. The architectural structure according to claim 13, further comprising:
two transparent plates;
at least one out of the at least one photoelectric conversion element and/or a module of photoelectric conversion elements being sandwiched between the two transparent plates.
